(19) United States
(12) Patent Application Publication
(10) Pub. No.: US 2014/0338237 A1
(43) Pub. Date: Nov. 20, 2014

(54) VEHICLE SIGN DISPLAY EMPLOYING SEMICONDUCTOR LIGHTING ELEMENTS

(71) Applicants: Yun-Ping Chu, Plano, TX (US); Jerry Lin, Rowland Heights, CA (US); Yongchan Wang, Diamond Bar, CA (US); Ren-Chen Chao, Taoyuan City (TW); Chin-Tin Hsiao, Taoyuan City (TW); Chih-Li Wang, New Taipei (TW); Fang-Ying Huang, New Taipei (TW)

(72) Inventors: Yun-Ping Chu, Plano, TX (US); Jerry Lin, Rowland Heights, CA (US); Yongchan Wang, Diamond Bar, CA (US); Ren-Chen Chao, Taoyuan City (TW); Chin-Tin Hsiao, Taoyuan City (TW); Chih-Li Wang, New Taipei (TW); Fang-Ying Huang, New Taipei (TW)

(21) Appl. No.: 13/898,416

(22) Filed: May 20, 2013

(51) Int. Cl. G09F 9/30; G09F 13/00

(52) U.S. Cl. CPC G09F 9/30; G09F 13/00
USPC 40/452

(57) ABSTRACT

An illuminated electronic display sign suitable for a transit vehicle comprises a support frame with a mounting surface, a plurality of lighting elements disposed on or attached to the mounting surface, and electronic circuitry configured to provide commands to selectively illuminate the lighting elements so as to create text or other information thereon. The lighting elements each comprise a semiconductor-based light source and an optical cap, each having a transparent layer portion and a diffusion layer portion. The optical caps may be generally rectangular in shape, aligned in a two-dimensional grid having rows and columns and are substantially adjacent to one another, with narrow gaps therebetween for increased display area. The optical caps may be asymmetrical, with a flat upper portion and a gradually tapering top surface to help reduce glare. A control system including wireless circuitry may be used to control multiple electronic display signs.

### BACKGROUND OF THE INVENTION

1) Field of the Invention

The field of the present invention generally relates to lighting systems and, more particularly, to lighting systems used for transit vehicles or conveyances such as buses, lightrail cars, and the like.

2) Background

Transit vehicles such as buses and other similar conveyances often are outfitted with external illuminated signs that function to display destination or route information. These signs may display a route number, for instance, or else a final or intermediate street or local destination. External display signs are commonly placed at least in the front of a transport vehicle, as a “headsign”, and on the boarding side of the vehicle. Display signs may also be placed on the back of the vehicle, in front of the vehicle's front dash, and/or on the non-boarding (street) side of the vehicle.

In many cases, these external display signs need to comply with governmental or regulatory requirements that dictate certain aspects of appearance. For example, Section 1192.39 of the Code of Federal Regulations (C.F.R.), Chapter 36, which contains accessibility guidelines for transportation vehicles in the United States, currently requires that characters on exterior signs have a certain width-to-height ratio (between 3:5 and 1:1) and a certain stroke width-to-height ratio (between 1:5 and 1:10). That section also requires a specified minimum character height of 1 inch for signs on the boarding side and 2 inches for front “headsigns” with relatively “wide” spacing; that is, the space between letters should be 1/16 the height of the upper case letters. The rules further generally require that the letters contrast with the background, either dark-on-light or light-on-dark. Thus, any external vehicle signs for the transport industry must generally be designed to meet certain specific guidelines in terms of lettering size and spacing.

Historically, many exterior vehicle signs have employed flip-disc or flip-dot technology. Such technology involves an electromechanical dot matrix display that has also been used for large outdoor billboards and advertising signs. The flip-disc or flip-dot display consists of a grid of small metal discs that are dark on one side and a bright color, such as white or yellow, on the other. The discs are magnetically controlled, and when a power signal is applied to a given disc it can be flipped from one side to the other. A computerized controller may receive text character inputs and then generate the appropriate control signals to change the states of the discs so as to duplicate the desired text on the external flip-dot grid.

In recent years, efforts have been made to use light-emitting diodes (LEDs) to provide illumination for vehicle-mounted external display signs. However, such LED-based external display signs have a number of challenges and drawbacks. For example, until recently, LEDs were not bright enough to be viewed easily in sunlight conditions. Since many buses and transit vehicles run during daytime, LEDs without sufficient brightness or contrast to be seen in daytime would not be suitable for use in external display signs. Although attempts have been made to utilize LEDs for vehicle display signs, such efforts appear to be less than satisfactory. Conventional LED-based external display signs, for instance, commonly use grids of 3 millimeter LEDs for sign illumination. These small LEDs create a harsh light appearing as a collection of sharp pinpoint sources. The LEDs also tend to have wide gaps between them. The harsh pinpoint light and poor fill factor of conventional signs, coupled with the small size of the LEDs, can make it difficult for readers to immediately recognize the information being presented.

Increasing the fill factor for LED-based external display signs is, in general, an inadequate solution to the above problems. The additional LEDs would significantly increase cost as well as power usage requirements. Typically a transit vehicle has only limited power (e.g., 10 Amps) available for external signage. The extra LEDs may also increase the heat generated by the display sign and create a potential risk of flammability. Also, additional LEDs would not necessarily alleviate the problem of the harsh pinpoint light generated by 3 mm LEDs.

Another challenge with external display signs relates to their integration with the rest of the vehicle's systems. For example, adding or retrofitting new external vehicle display signs to an existing vehicle may entail costly and difficult wiring additions. Even on new vehicles, the wiring to connect a controller to the display signs dispersed over different areas of the vehicle may be costly and inconvenient.

It would therefore be advantageous to provide a display signal that overcomes some or all of the disadvantages, limitations or challenges described above, and/or provides additional or other benefits and advantages. It would further be advantageous to provide an external display board that is suitable for use in daylight or darkness, is easy to read from a distance and from different angles, and is power efficient and of modest cost. It would further be advantageous to provide a display board system that is relatively easy to deploy or retrofit to existing vehicles, and is generally inexpensive or not overly complex to implement or deploy.

### SUMMARY OF THE INVENTION

Exemplary embodiments disclosed herein are generally directed, in one aspect, to a novel external illuminated display sign that is particularly well suited for a transit vehicle or similar conveyance, but which may find other uses or applications as well, such as for example indoor or outdoor electronic billboards or signage.

According to one embodiment as disclosed herein, a vehicle display sign, as may be used for example on an external location of a transit vehicle, comprises a two-dimensional grid of enlarged semiconductor based lighting elements (such as LEDs) that are disposed close together, with only a small gap between them. The illuminable surface of the enlarged semiconductor based light elements is preferably in a shape (such as generally square or rectangular) that result in an increase of the area filled by each light element and hence an increase in total surface coverage. Further, the semiconductor light element may have a diffusion cover, cap or portion to reduce the sharpness of the point light source, or may have a textured or roughened surface to achieve a similar effect. The larger illuminated surface of the semiconductor light elements along with the reduced gap between adjacent light elements and broader, smoother light surface of each element collectively contribute to an information display that can be easier to read or provide other benefits.

In a particular embodiment, a semiconductor lighting element in the form of a light-emitting diode (LED), useful for a display sign or other purposes, includes a light-emitting source or base portion, over which is disposed an optical cap. The light-emitting source may comprise, for example, a through-hole LED or a surface-mount LED. According to one embodiment, an LED is surrounded by an optical cap that is generally square or rectangular in shape, and of sufficient volume to allow the light from the light-emitting source to spread outwards to occupy an area substantially larger than the point source. The optical cap may be multi-layer, with a lower portion (preferably transparent), and an upper layer or surface providing diffusive qualities to help reduce the sharpness of the point light source and provide a smoother, more even illumination across the surface of the optical cap. The optical cap may be selectively tapered, with an upper flat side that may have the effect of reducing or preventing glare and providing more clarity of viewing, regardless of the angle of incident sunlight or other ambient light.

An electronic display sign with enlarged semiconductor light elements providing enhanced clarity and visibility may be mounted, for example, as an external headboard display for a transit vehicle, and may also be used as a side or rear sign display, and/or a dash display board. The various external display signs on a transit vehicle may be controlled by a central controller accessible to a driver, technician, or other operator, and may communicate with the central controller either through a wired or wireless connection. The electronic display signs may be used for generating text, messages, or other information that is viewable by passengers (if a vehicle) or occupants of the area. The display sign may have different modes, for example a daytime mode and nighttime mode, with different operation depending upon the time of day or the ambient lighting conditions.

Further embodiments, variations and enhancements are also disclosed herein.

### BRIEF DESCRIPTION OF THE DRAWINGS

FIG. 1 is a diagram of a transit vehicle showing examples of possible locations for external electronic display signs.

FIG. 2 is an oblique view of a preferred module for an electronic display sign as may be externally mounted on a transit vehicle or used for other purposes, according to one embodiment as disclosed herein.

FIG. 3 is a diagram illustrating a sample comparison of readability and visibility of an electronic display sign constructed according to the design shown in FIG. 2, versus a conventional display sign made with small, round light-emitting diodes.

FIGS. 4A-4D are diagrams from different perspectives of a preferred embodiment of an electronic display sign module constructed according to the basic design shown in FIG. 2, which can be utilized by itself or for larger signs in series combinations. FIG. 4A shows a rear oblique view of the electronic display sign module, while FIG. 4B shows a top view of the electronic display sign module, FIG. 4C shows a front view and side/cross-sectional views, and FIG. 4D shows a rear view.

FIGS. 5A-5D are diagrams from various perspectives showing an example of an electronic display sign constructed from a series of display sign modules such as illustrated in FIGS. 4A-4D, for example, according to an embodiment as disclosed herein. FIG. 5A shows a top view of the electronic display sign, while FIG. 5B shows a front view and side/cross-sectional views of the electronic display sign, FIG. 5C shows a rear view, and FIG. 5D shows an oblique frontal view.

FIG. 6 is a diagram comparing side and top views of one example of a semiconductor lighting element as may be used in various embodiments as disclosed herein, with conventional round light-emitting diodes (LEDs) of two different sizes.

FIGS. 7A-7D are diagrams from various perspectives of a first example of a semiconductor lighting element with an optical cap as may be used in connection with various electronic display signs as disclosed herein, according to one embodiment as disclosed herein.

FIGS. 8A-8D are diagrams from various perspectives of a second example of a semiconductor lighting element with an optical cap as may be used in connection with various electronic display signs as disclosed herein, according to another embodiment as disclosed herein.

FIGS. 9A-9D are diagrams from various perspectives related to a third example of a semiconductor lighting element with an optical cap as may be used in connection with various electronic display signs as disclosed herein, according to yet another embodiment as disclosed herein.

FIG. 10 is a block diagram of a system including electrical components for controlling and operating a set of electronic display signs, in accordance with an example of one embodiment.

FIG. 11 is a block diagram of system for controlling and operating a set of electronic display signs according to one example using primarily wired connections to a central controller.

FIG. 12 is a block diagram of system for controlling and operating a set of electronic display boards according to one example using primarily wireless connections from the electronic display signs to a central controller.

FIGS. 13A and 13B are front and rear view diagrams, respectively, illustrating an example of a control unit that may be used in connection with the electronic display signs as disclosed herein, for operating or controlling them and interfacing with a transit vehicle driver or other operator.

### DETAILED DESCRIPTION OF PREFERRED EMBODIMENT(S)

According to various embodiments as disclosed herein, an electronic display sign for a transit vehicle or other similar setting comprises light elements, preferably in the form of semiconductor-based lighting elements such as LEDs, arranged in a two-dimensional grid for displaying text or other graphical information. In certain embodiments, the electronic display sign may include one or more of the following features: (i) a frame with a mounting surface, (ii) a plurality of enlarged semiconductor-based lighting elements (such as LEDs) preferably arranged in a two-dimensional grid pattern; (iii) an optical cap disposed on or integral with the semiconductor-based lighting elements; and/or (iv) a diffusion cover, cap or portion as part of the optical cap of each of the semiconductor-based lighting elements. The optical cap may, in various embodiments, be generally square or rectangular in shape, and of sufficient height or volume to allow the light from the light-emitting source to spread outwards to occupy an area substantially larger than the point source before reaching the topmost surface of the optical cap. In certain embodiments, the optical cap is multi-layer, with a lower portion (preferably transparent), and an upper layer or surface providing diffusive qualities to help reduce the sharpness of the point light source and provide a smoother, more even illumination across the surface of the optical cap. The optical cap may also, in certain embodiments, be selectively tapered, with an upper flat side that may have the effect of reducing or preventing glare and providing more clarity of viewing, regardless of the angle of incident sunlight or other ambient light.

According to certain embodiments, an electronic display sign with enlarged semiconductor light elements provides enhanced clarity and visibility for use as an external sign display for a transit vehicle, and may be used on the front headboard, dash area, side regions, or rear area of a transit vehicle. The external display signs on a transit vehicle may be controlled by a central controller, and can be used for generating text, messages, or other information that is viewable by passengers or others.

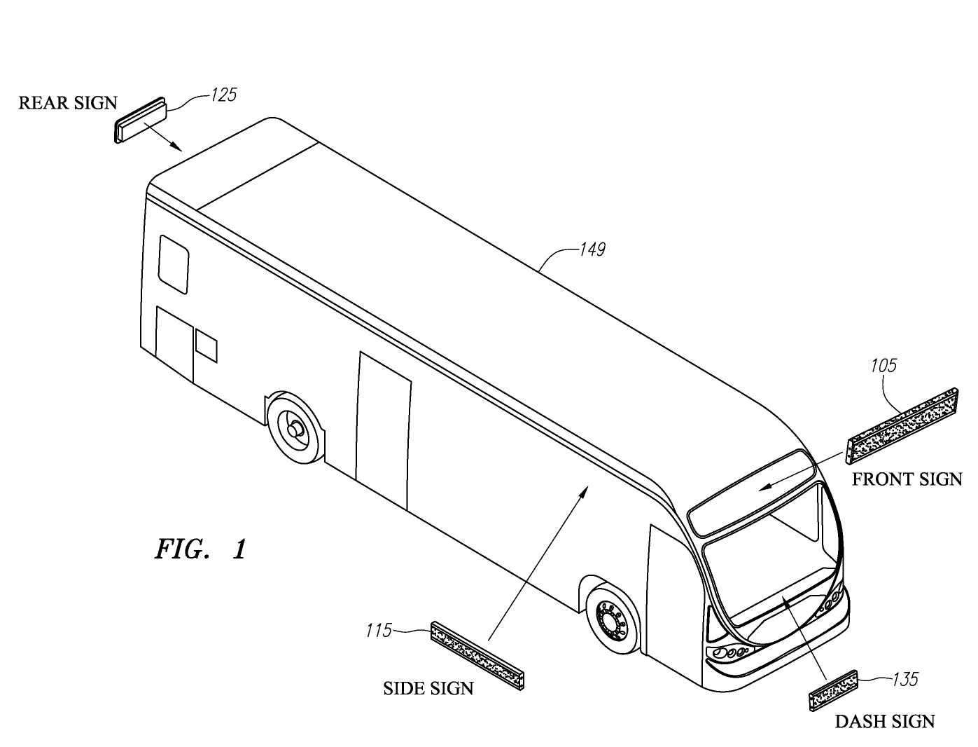

FIG. 1 is a diagram of a transit vehicle 149 showing examples of possible locations for one or more external electronic display signs 105, 115, 125, 135. As shown therein, a first electronic display sign 105 may be placed in the headboard area of the transit vehicle 149, above the windshield. A second electronic display sign 115 may be placed on the door side of the transit vehicle 149. A third electronic display sign 125 may be placed on the rear of the transit vehicle, and a fourth electronic display sign 135 may be placed in the dash area of the front of the transit vehicle 149. In addition, another electronic display sign (not shown) may be positioned on the driver's side (in this case the left side) of the transit vehicle 149. Some or all of the electronic display signs 105, 115, 125, 135 illustrated in FIG. 1 may be of the type constructed in accordance with the inventive embodiments disclosed herein, but in other cases some of the electronic display signs may be of a conventional or other design.

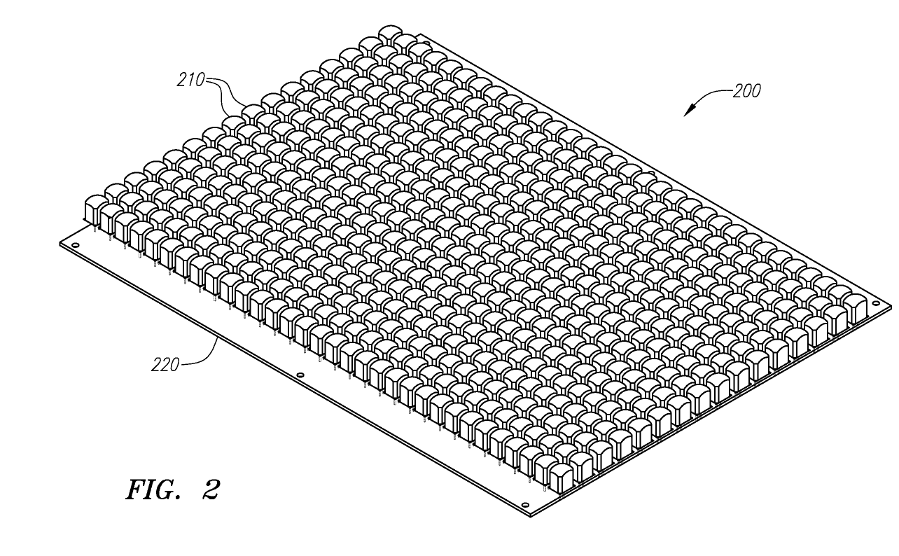

Embodiments of external display signs disclosed herein may, in various instances, include a plurality of enlarged semiconductor-based lighting elements (such as LEDs) preferably arranged in a two-dimensional grid pattern. FIG. 2, for example, is an oblique view of a layout arrangement of module 200 for an electronic display sign as may be externally mounted on a transit vehicle or used for other purposes, according to one embodiment as disclosed herein. As shown in FIG. 2, the module 200 includes a plurality of semiconductor-based lighting elements 210, with light sources such as LEDs supplemented with an optical cover or other component, and generally arranged in a two-dimensional grid pattern. The semiconductor-based lighting elements 210 may be mounted or otherwise disposed on a mounting surface such as a substantially flat printed circuit board 220, or other mounting surface. Although FIG. 2 illustrates the general size and layout of the semiconductor-based lighting elements 210, it should be noted that the module 200 in practice would have a number of additional structures and components, which are omitted from FIG. 2 for clarity but are shown in other diagrams disclosed herewith.

Although lighting elements of any color can be used, including white, in a preferred embodiment, the lighting elements 210 are yellow or amber in color, which may provide increased contrast in an outdoor setting, particularly when employed in the particular constructs as described herein. In other embodiments, other colors of lighting elements can be used, and/or multiple colors can be used as well.

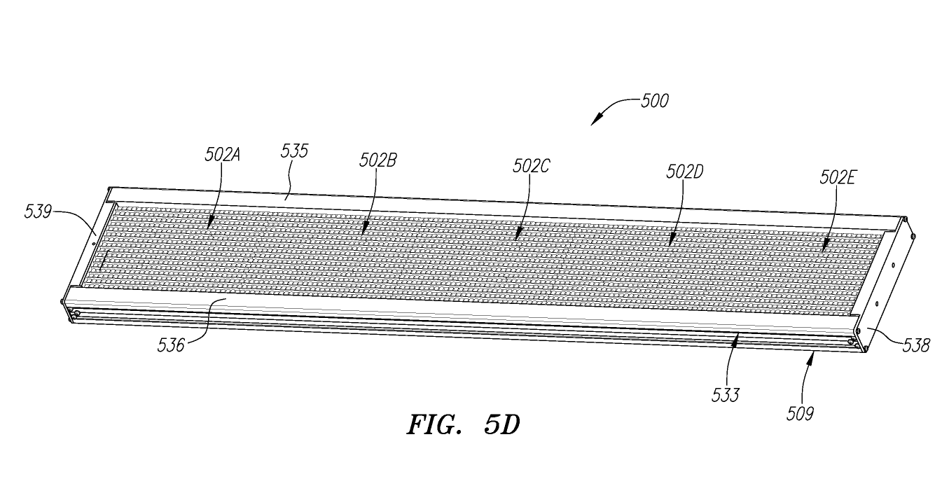

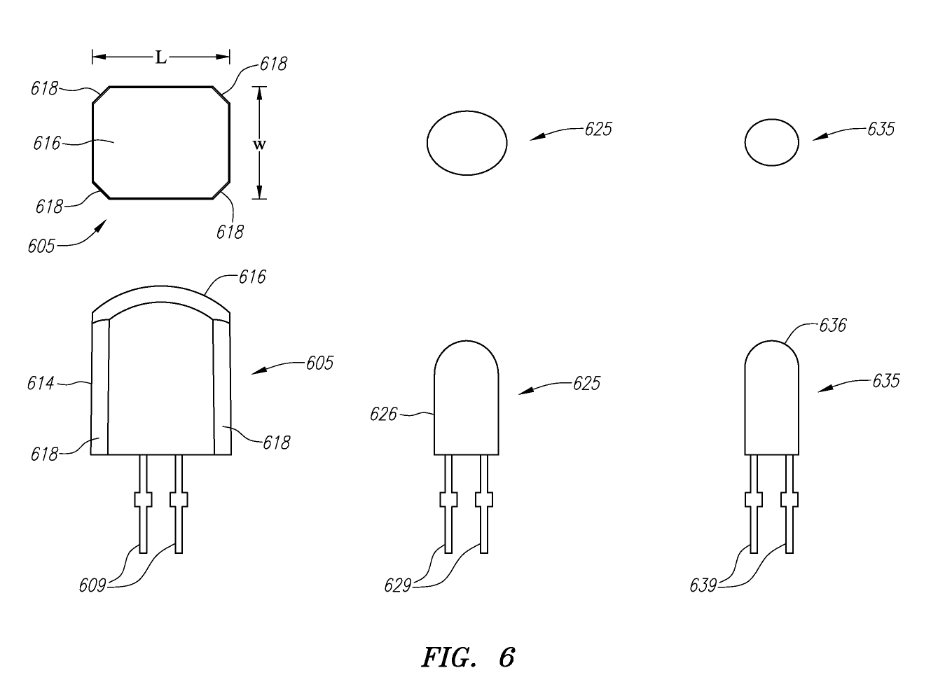

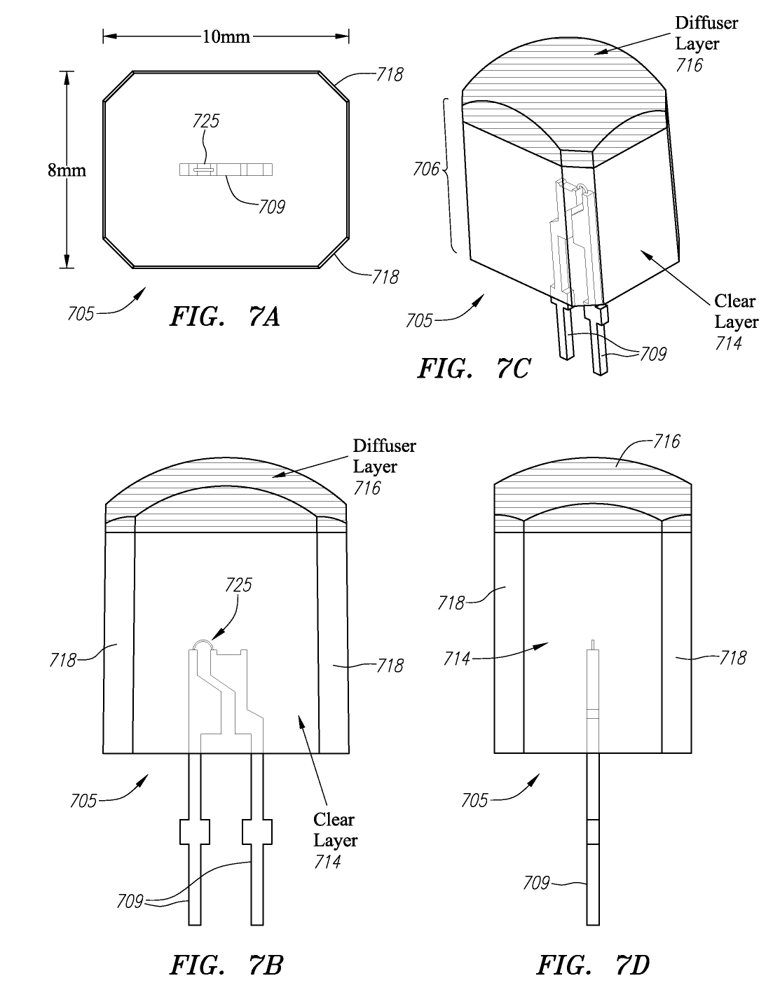

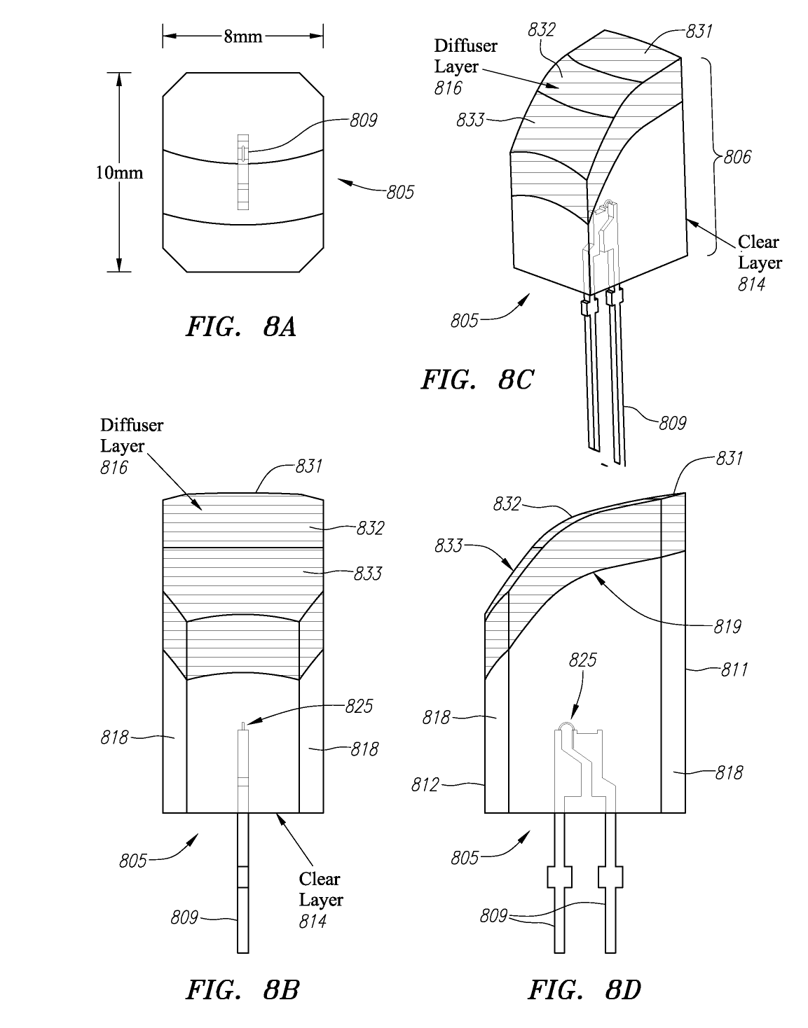

In this example, there are 16 rows and 32 columns of semiconductor-based lighting elements 210, although any number of rows and columns may be used, depending upon the signage needs. Preferably, the semiconductor-based lighting elements 210 are significantly larger than conventional 3 millimeter or 5 millimeter round LEDs, and may each be generally rectangular in shape as viewed from above. Further, the semiconductor-based lighting elements 210 may be arranged so that the gaps between them are relatively narrow, so that the fill factor of the entire surface area of the module 200 is increased. Because the semiconductor-based lighting elements 210 are relatively large, fewer are needed to populate the module 200 as compared to smaller, conventional LEDs, which in turn may provide benefits such as reduced the power requirements of the module 200 or decreased manufacturing and maintenance expense. A variety of examples of semiconductor-based lighting elements 210 are described herein and illustrated, for instance, in FIGS. 6, 7A-7D, 8A-8D and 9A-9D, which are discussed in more detail below.

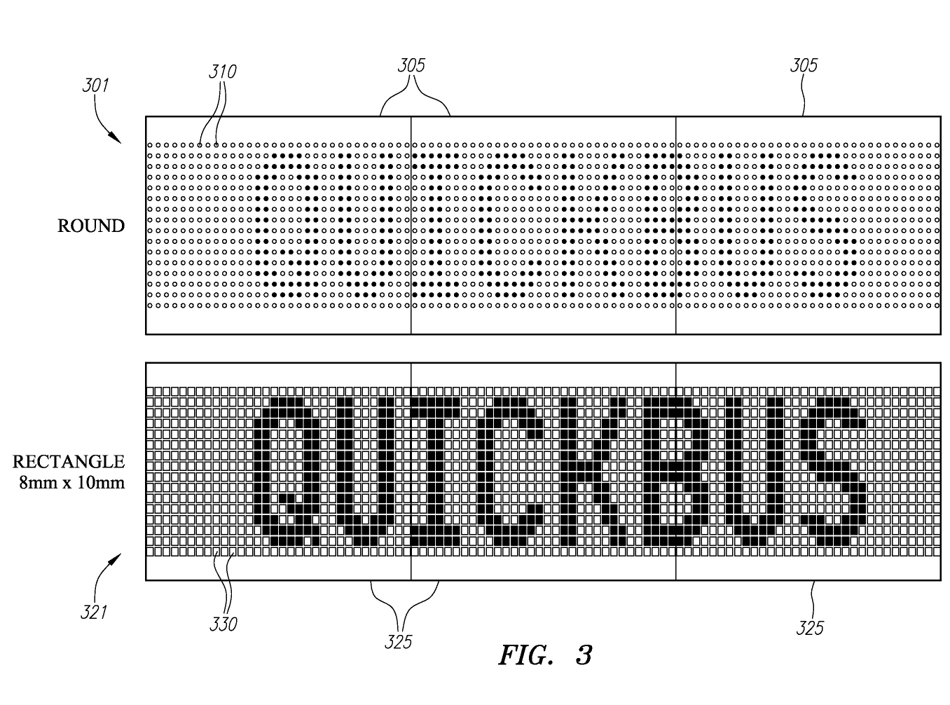

Among other benefits of lighting modules and display signs made in accordance with the design of FIG. 2, is the potential for increased readability and clarity of text and other information displayed on the sign. FIG. 3 is a diagram illustrating a sample comparison of readability and visibility of an electronic display sign 321 constructed according to the module design shown in FIG. 2, versus a conventional display sign 301 made with smaller, round light-emitting diodes 310. In FIG. 3, the conventional electronic display sign 301 is shown, for purposes of comparison only, having several lighting modules 305 of roughly the same physical size as the module 200 in FIG. 2. Each of the lighting modules 305 has a two-dimensional grid of conventional round LEDs 310 of, e.g., 3 millimeter size. Electronic display sign 321, on the other hand, is comprised of several lighting modules 325 of the general design of FIG. 2, with enlarged semiconductor-based lighting elements 330 that have relatively narrow gaps between them. In this particular example, the enlarged semiconductor-based lighting elements are illustrated as being approximately 8×10 millimeters in size as viewed from the top, although other sizes are also possible, and both of the electronic display signs 301, 321 are illustrated with a 10 mm×13 mm pitch (i.e., spacing between lighting elements). The same number of lighting elements is found on both electronic display signs 301, 321. However, the illustrated text (“QUICKBUS”), reproduced in dark on a light background, is much clearer with the electronic display sign 321. Both the larger size of the semiconductor-based lighting elements 330 and the reduced gaps between them (without requiring additional lighting elements over the conventional design) contributes to the increased readability and clarity. In addition, the electronic display sign 321 made with the enlarged semiconductor-based lighting elements 330 may be constructed such that its power consumption is in the same general range as the “conventional” electronic display sign 301 shown in FIG. 3.

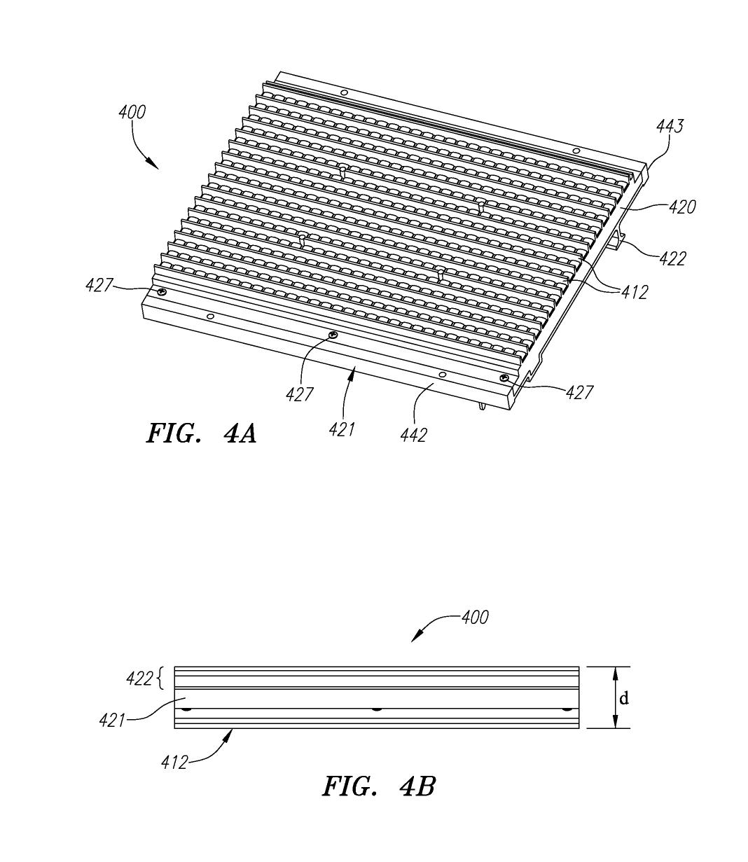

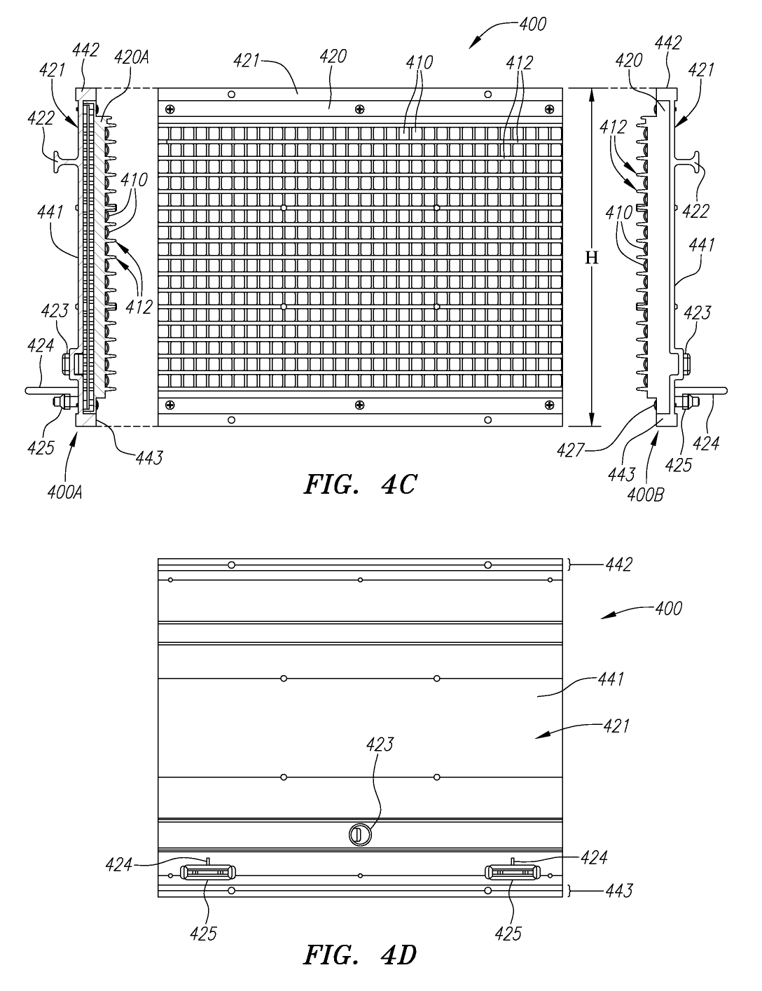

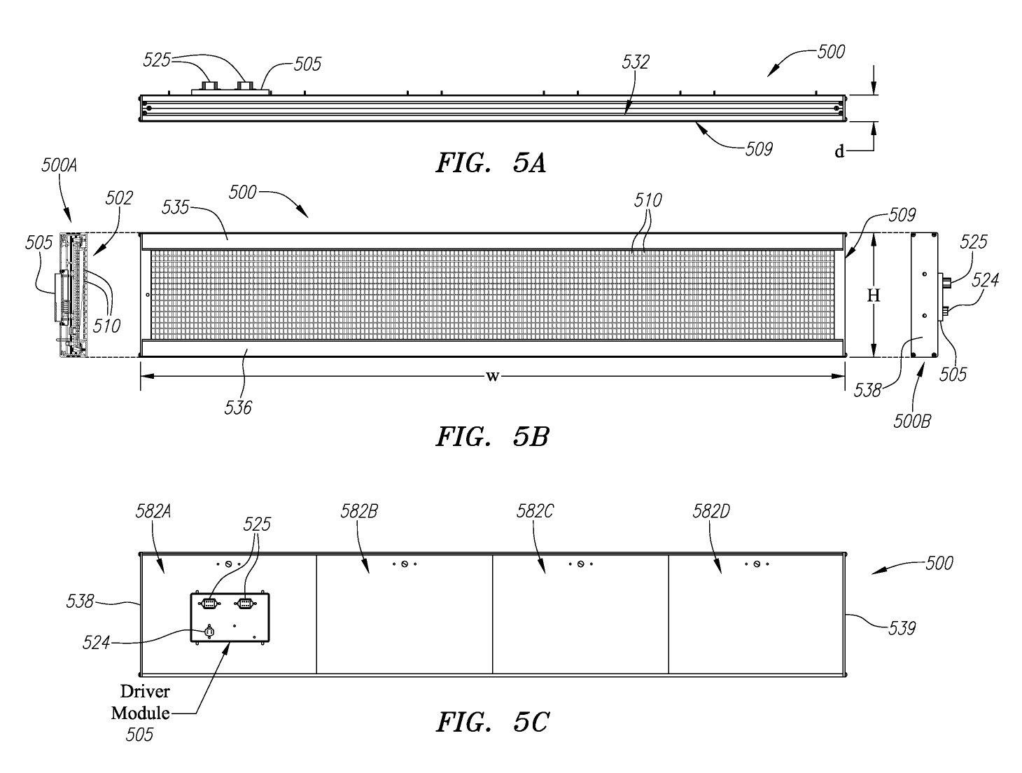

Further details of one example of a preferred lighting module for an electronic display sign are shown in FIGS. 4A-4D, while details of an example of a preferred electronic display sign are shown in FIGS. 5A-5D. FIGS. 4A-4D are diagrams from different perspectives of a lighting module 400 constructed according to the basic design shown in FIG. 2, with FIG. 4A showing a rear oblique view of the lighting module 400, FIG. 4B showing a top view of the lighting module 400, FIG. 4C showing a front view and side/cross-sectional views of the lighting module 400, and FIG. 4D showing a rear view of the lighting module 400. Turning first to FIG. 4C, the lighting module 400 of this example is shown in frontal view with a two-dimensional grid of semiconductor-based lighting elements 410 arranged thereon. In FIG. 4C, the lighting module is also illustrated in side view (as 400B) and cross-sectional view (as 400A), aligned with the frontal view (shown as 400) for purposes of illustration. The lighting module 400 (as further depicted as 400A and 400B) may be constructed with an outer frame member 421 having a generally flat back plate 441 integrally formed with a top ridge 442 and a bottom ridge 443. A mounting board assembly 420 conforming to the interior dimensions of the outer frame member 421 may be disposed within the outer frame member 421, surrounded on three sides by the flat back plate 441, top ridge 442 and bottom ridge 443. The semiconductor-based lighting elements 410 are preferably disposed on a mounting surface of the mounting board assembly 420.

The mounting board assembly 420 may optionally be outfitted with a plurality of parallel horizontal slats 412 running across the length of the mounting board assembly 420, defining a set of parallel horizontal grooves in which the semiconductor-based lighting elements 410 are disposed, and shorter parallel vertical slats 420A (see FIG. 4C) defining a set of parallel vertical grooves in which the semiconductor-based lighting elements 410 are disposed. Collectively, the vertical slats 420A and horizontal slats 412 form small “pockets” in which the semiconductor-based lighting elements 410 are disposed, and as shown in the side views 400A and 400B of the lighting module 400 in FIG. 4C, only the top of the lighting elements' optical caps are visible above the height of the vertical slats 420A. The parallel slats 412 and/or 420A, and the pockets formed thereby, may provide protection or added stability for the semiconductor-based lighting elements 410. While the horizontal slats 412 and vertical slats 420A are shown as being different heights, both sets of slats 412, 420A could alternatively be the same height, either taller like the horizontal slats 412 or shorter like the horizontal slats 420A. As noted previously, the semiconductor-based lighting elements 410 are preferably relatively large (e.g., 8×10 millimeters in size, from top view), and generally rectangular in shape, in order to maximize the space they fill within the surface region of the lighting module 400. As shown in FIG. 4C, the semiconductor-based light elements 410 are illustrated with rectangular optical caps in place, although largely hidden from view in depictions of lighting module 400A and 400B. In various embodiments, the optical caps of the semiconductor-based lighting elements 410 may be approximately equal in size to the depth of the slats 412, or may be slightly lower than the top edge of the slats 412, or else may protrude slightly above the top edge of the slats 412.

For semiconductor-based lighting elements 410 employing through-hole LEDs as light sources, the pins of the LED may be soldered on to a circuit board or similar surface, then the circuit board incorporated as part of the mounting board assembly 420 with the addition of the lattice provided by horizontal and vertical slats 412 and 420A. For semiconductor-based lighting elements 410 employing surface mount LEDs as light sources, the optical caps may be inserted from the back into the lattice structure of the mounting board assembly 420 and attached thereto (e.g., with epoxy or by other means). To facilitate retention of the optical caps, each “pocket” defined by adjacent horizontal and vertical slats 412 and 420A may optionally have a small frontal retaining rim or tabs, although such are not necessary in other embodiments. Once the optical caps are in place, a circuit board attached to form a backing of the mounting board assembly. In either of the above examples, the outer frame member 421 is thereafter added to enclose and protect the overall assemblage.

To provide a desirable surface coverage, it is preferred that the slats 412 be relatively thin, and that the gaps between the semiconductor-based lighting elements 410 be relatively narrow. For example, where the semiconductor-based lighting elements 410 are 8×10 millimeters in size (from a top view), the gap between adjacent lighting elements is preferably less than 4 millimeters and more preferably between 2 and 3 millimeters or less. The gap width may also be different for rows and columns. For example, the gap between adjacent columns may be in the range of 2 millimeters, and the gap between adjacent rows may be in the range of 3 millimeters. The cumulative surface area occupied by the optical caps of the semiconductor-based lighting elements 410 is preferably large enough to provide an easily visible and relatively continuous appearing display panel for presenting text and possibly other information, and may, for example, exceed the total surface area of the gaps between the lighting elements, and could easily occupy twice as much or more the total surface area of the gaps between the lighting elements.

The outer frame member 421 of the lighting module 400 may be secured to the mounting board 420 using, for example, a screw 423 which is inserted into a threaded screwhole that passes through both, and/or by screws 427, or by any other suitable means. The lighting module 400 may further have one or more electrical connection sockets 425, which may be located on the back plate 441 of the outer frame member 421 (see FIGS. 4C and 4D), for connecting cables (not shown) that provide data and/or power to the electronics of the lighting module 400. The outer frame member 421 may also be provided with a rear support member 422 that may serve, for example, to elevate the lighting module 400 from a surface or wall to which it is attached, thereby creating an airgap between the lighting module 400 and the surface to which it is attached and facilitating cooling of the lighting module 400 during operation. Additional support members 424 may be provided in the lower area of the outer frame member 421, proximate the connection sockets 425, to ensure there is enough clearance for electrical plugs once the lighting module 400 is integrated (if desired) in a larger frame or display sign. As illustrated or described later herein, the rear support members 422 and 424 may be attached to or supported by the back wall of an enclosing outer frame such as 509 illustrated in FIGS. 5A-5D.

The outer frame member 421 of the lighting module 400 may be constructed of any suitable material, and is preferably manufactured from aluminum or other metal or alloy that is efficient at dissipating heat that is generated by the semiconductor-based lighting elements 410. The outer frame member 421 may be of singular construction or else may be fashioned from a series of pieces that are assembled together. The mounting board assembly 420 may generally be manufactured from aluminum or other metal or alloy, or may be made of lightweight plastic or composite material. In certain embodiments, the mounting board assembly 420 may have a circuit board (not shown separately) as its top mounting surface, on which the semiconductor-based lighting elements 410 are disposed.

The lighting module 400 may be combined with additional lighting modules to form a larger electronic display sign. An example of such an electronic display sign is illustrated in FIGS. 5A-5D, which are diagrams from various perspectives showing an example of an electronic display sign 500 that may be constructed from a series of display sign modules 502A-E each similar to the module illustrated in FIGS. 4A-4D, for example, according to an embodiment as disclosed herein, or else may be constructed from a single large frame and mounting surface. More specifically, FIG. 5A shows a top view of the electronic display sign 500, while FIG. 5B shows a front view and side/cross-sectional views of the electronic display sign 500, FIG. 5C shows a rear view of the electronic display sign 500, and FIG. 5D shows an oblique frontal view of the electronic display sign 500.

Turning first to FIG. 5D, the electronic display sign 500 may be composed, as shown, of a set of lighting modules 502A-E which, in this example, are serially connected to form an elongate structure. At least one of the lighting modules, for example the first lighting module 502A, may be outfitted with a driver module 505 (see FIG. 5C) having one or more electrical connection sockets 525 for receiving data and/or power signals from an upstream command source. The signals received at electrical connection sockets 525 may be distributed by cables or wiring within the outer frame 509 to the separate lighting modules forming the electronic display sign 500. The driver module 505 may also have an additional connection socket 524 for receiving a power input, which may be derived for example from a vehicle battery. In a preferred embodiment, the lighting modules 502A-E are electrically coupled in a daisy-chain fashion to propagate data and/or power signals from one lighting module to the next.

Turning now to FIG. 5B, the electronic display sign 500 may have an outer frame 509 for securing or containing the individual lighting modules 502A-D, with overhanging plates 535, 536 securing the lighting modules 502A-D and helping protect them against the elements as well as dust, dirt, and the like. In FIG. 5B, the electronic display sign 500 is (similar to FIG. 4C) also illustrated in side view (as 500B) and cross-sectional view (as 500A), aligned with the frontal view (shown as 500) for purposes of illustration. As shown in the side view depiction of the electronic display sign 500B in FIG. 5B, as well as in FIGS. 5C and 5D, the outer frame 509 may also be capped at either end with side panel members 538 and 539. The outer frame 509 may also include an upper frame member 532 (FIG. 5A), a lower frame member 533 (FIG. 5D), and one or more rear frame members 582A-D (FIG. 5C). As shown in the cross-sectional depiction of the electronic display sign 500A in FIG. 5B, the individual lighting modules 502 may be contained within the outer frame 509 including the overhanging plates 535, 536, thus forming an integral unit.

By combining multiple lighting modules 502A-E together to form a singular electronic display sign 500, it is possible to create display signs of different lengths for different needs or vehicles. In the example of FIGS. 5A-5D, five lighting modules 502A-E are used, but fewer or more lighting modules 502 may be similarly combined to make a shorter or longer electronic display sign 500. The semiconductor-based lighting elements 510 of the lighting modules 502A-E align so as to create an enlarged two-dimensional grid, as illustrated for example in FIGS. 5B and 5D. The electronic display sign 500 may be mounted on a suitable location of a transit vehicle, for example, and may be connected to digital data cables and power cables in order to receive appropriate commands and power for operation.

In the particular example of FIGS. 5A-5D, the electronic display sign 500 is approximately 65 inches (1650 mm) in length, 11.5 inches (292 mm) in height, and 2.5 inches deep. The display area is roughly 63 inches (1600 mm) by 8.19 inches (208 mm), assuming a 10 mm×13 mm pitch, for a total surface area of 3.58 square feet (0.333 square meters). In this example, the resolution is 16 rows by 160 columns of lighting elements 510, for a total of 2560 lighting elements, with each of the individual lighting modules 502A-E having an 8×16 grid of lighting elements. At a rated power of 10 milliwatts per lighting element, for example, the electronic display board would consume a maximum of 25.6 Watts of power assuming all lighting elements were illuminated simultaneously. Normally, however, only some fraction such as 30% to 50% of the lighting elements are illuminated at a given time. For lighting elements of 100 milliwatts rated power, the maximum theoretical power draw would be about 256 Watts, and so on. Lighting elements may be selected such that the total power draw of the electronic display sign 500 is less than 10 Amps, which is a desirable upper limit in the context of transit vehicles. Where the lighting elements are placed in series of 8 or 16 units, thus sharing the same current path, a total current draw of less than 10 Amps is achievable for lighting elements drawing 25 milliamps apiece. Despite the low power usage, the electronic display sign 500 may achieve excellent surface coverage, clarity, and visibility.

As previously noted, a preferred semiconductor-based lighting element for use in an electronic display sign is relatively large and preferably includes an optical cap to provide an expanded but modestly diffused light source. A variety of examples of semiconductor-based lighting elements as may be used with the novel electronic display sign embodiments as disclosed herein are depicted in FIGS. 6, 7A-7D, 8A-8D and 9A-9D. Starting first with FIGS. 7A-7D, one example of a semiconductor-based lighting element 705 is illustrated in various perspectives, with FIG. 7A showing a top view, FIG. 7B showing a lengthwise side view, FIG. 7C showing an oblique view, and FIG. 7D showing a widthwise side view. As shown in FIGS. 7A-7D, the semiconductor-based lighting element 705 is constructed in this example with a light-emitting diode (LED) 725 preferably of the through-hole variety, surrounded by an optical cap 706. The LED 725 may, for example, be of conventional design (having a semiconductor die atop a leadframe), and can be of any suitable power rating although it is preferably in the range of 50-100 milliwatts. For example, a 3.3 Volt LED drawing 25 milliamps would consume about 82 milliwatts, or modestly under 100 milliwatts. The LED 725 has two electrical connectors 709, i.e., anode and cathode pins, which are to be connected to an electric power source for selectively powering the LED 725, thereby turning it on and off.

In this particular embodiment, the optical cap 706 is a multi-layer structure composed of a first layer 714, which may be transparent or clear, and a second layer 716, which may be so constructed as to provide diffusion for illumination from the LED 725. The semiconductor-based lighting element 725 may advantageously be constructed from a single concave mold (not shown), with a first semi-opaque material (such as tinted or semi-opaque plastic or epoxy) added to the base of the mold to form the diffusion layer 716, and a second material (such as transparent plastic or epoxy) added next to form the transparent layer 714. The diffusion layer 716 may also be formed in whole or part with a textured surface as opposed to a different material from the transparent layer 714. The LED 725 may be inserted into the top of the transparent layer 714 while the plastic or epoxy is still in a semi-liquid state. The optical cap 706 may be so molded without the use of an integral outer shell in which to contain the plastic or epoxy and which would form part of the optical cap when completed. Rather, either or preferably both the diffusion layer 716 and the transparent layer 714 may be of uniform material construction.

The convex nature of the optical cap 706 may provide particular benefits to viewing angle, allowing pedestrians to see the display sign clearly from a variety of different angles. Preferably, the size and curvature of the convex surface of the optical cap 706 is such as to provide approximate a 120° side-to-side viewing angle.

The dimensions of the optical cap 706 of the semiconductor-based lighting element 705 may be selected so as to be of suitable size and shape so as to provide a pixelated element of a high fill-factor two-dimensional grid as shown, for example, in FIGS. 2, 3 and 4C. The optical cap 706 is preferably of a large enough size so as to substantially fill the two-dimensional grid when populated with semiconductor-based lighting elements 705 of the same type, but small enough to provide adequate resolution when forming pixelated text on the electronic display sign. For similar reasons, the optical cap 706 may be generally rectangular in shape, when viewed from the top and as it will appear when positioned on an electronic display sign, although other shapes (such as hexagonal or triangular) may also be used. The area dimensions of the top surface of the optical cap 706 are preferably greater than 50 square millimeters, and may, for example, be in the range of 75-100 millimeters. In the example illustrated in FIGS. 7A-7D, and as shown particularly in FIG. 7A, the lengthwise dimension of optical cap 706 is 10 millimeters, and the width dimension of the optical cap 706 is 8 millimeters, for a total surface area of 80 square millimeters. Either of these dimensions may be varied depending upon the particular needs for a given application. In this example, the optical cap 706 has faceted corners with cuts 718 across each, although in other embodiments the corners may be sharp. The faceted corners may facilitate handling of the semiconductor-based lighting elements 705 and assembly of the electronic display signs made therewith.

The optical cap 706 is also preferably of sufficient height to allow the illumination from the LED 725 light source to spread so as to adequately fill the top surface area of the optical cap in a relatively even fashion, without reducing the light output to an excessive degree. In the example illustrated in FIGS. 7A-7D, the transparent layer 714 is approximately 10 millimeters in height, or about equal to the maximum lengthwise dimension. The LED 725 is positioned at about 4 millimeters height within the transparent layer. The diffusion layer 716 may have a convex surface as illustrated in FIG. 7B for instance, at its maximum width adding another 3 to 4 millimeters of distance from the LED 725 to the top surface of the optical cap 706. The thickness of the diffusion layer 716 also depends in part on the opacity of the material used to form that layer. Preferably, the diffusion layer 716 is constructed so as to scatter or diffuse at least some of the illumination from LED 725, reducing total light output in the process by somewhere in the range between 20% and 30%, and more preferably around 25%. While this has the effect of reducing the total luminosity of the semiconductor-based lighting element 705, it has the benefit of also reducing the sharpness of the LED 725 as a point light source and instead gives the lighting element 705 the appearance of more of a solid light block. Enough diffusion is preferably provided to avoid hotspots, but not so much as to result in a meaningful efficiency drop or reduction in clarity.

It is noted that the taller the optical cap 706, the more uniform will be the appearance of the light spot on the top surface, but also the amount of light will gradually grow dimmer and the cost of the optical cap 706 may increase. With a shorter optical cap 706, the light spot will be brighter but may appear smaller. Given the length and width dimensions of 10×8 millimeters, the diagonal dimension in this case would be 12.8 millimeters. Preferably, the ratio of height to diagonal (H:D) of the optical cap 706 is between about 1:0.59 and 1:2.36. Conversely, the ration of diagonal to height (D:H) is preferably between about 1:0.425 to 1:1.17. In a preferred embodiment, where the height of the optical cap 706 is about 10.86 millimeters, the ratio of height to diagonal is 1:1.18, and the preferred range of heights is thus between 5.44 and 21.76 millimeters.

FIG. 6 is a diagram comparing side and top views of a semiconductor-based lighting element 605 similar to that shown in FIGS. 7A-7D with conventional round light-emitting diodes (LEDs) 625, 635 of two different sizes. The semiconductor-based lighting element 605 in this example has a lengthwise dimension L and widthwise dimension W, which may be, for example, 10 millimeters and 8 millimeters, respectively, similar to the dimensions of the semiconductor-based lighting element 705 of FIGS. 7A-7D. Similarly, the semiconductor-based lighting element 605 is similar in shape and design to the one shown in FIGS. 7A-7D, having a first translucent layer 714 and a second diffusion layer 716, convex in surface, forming an optical cap having side facets 618. Also shown in FIG. 6 are the electrical pins 609 (anode and cathode) emanating from the bottom of the semiconductor-based lighting element 605. Next to it in FIG. 6, generally to scale, are a conventional 5-millimeter LED 625 having an upper transparent encasement 626 and electrical pins 629, and a conventional 3-millimeter LED 635 likewise having an upper transparent encasement 636 and electrical pins 639, shown from both side view and top view in alignment with the similar top or side views of semiconductor-based lighting element 605. The LEDs 625, 635 may either be generally round or more ovoid in shape, depending upon the manufacturer. As can be observed from FIG. 6, the surface area of semiconductor-based lighting element 605 is substantially larger than that of LEDs 625, 626. For example, the surface area of the 5-millimeter LED 625 is approximately 20 square millimeters, and that of the 3-millimeter LED 635 is approximately 7 square millimeters, whereas the surface area of the semiconductor-based lighting element 605 is approximately 75-80 square millimeters. Thus, the surface area of semiconductor-based lighting element 605 can be four to ten times as large, or more, of the surface area of LEDs 625, 635.

In addition to other differences, the LEDs 625, 635 can also be manufactured differently from semiconductor-based lighting element 605. For example, the transparent encasements 626, 636 are typically manufactured with an outer hard lens case that is filled with epoxy, whereas the optical cap 706 (see FIG. 7A) of the semiconductor-based lighting element 605 is preferably manufactured from a mold which is filled with epoxy, without the need for an outer hard lens case to hold the epoxy. Also, the encasements 626, 636 of LEDs 625, 635 generally are not “multi-layer” in construction.

The semiconductor-based lighting elements for the various electronic display signs described herein may be constructed in a variety of different shapes and sizes. For instance, FIGS. 8A-8D are diagrams from various perspectives of a second example of a semiconductor-based lighting element 805 with an optical cap 806 as may be used in connection with various electronic display signs as disclosed herein, according to another embodiment. Specifically, FIG. 8A shows a top view of the semiconductor-based lighting element 805, FIG. 8B shows a lengthwise side view, FIG. 8C shows an oblique view, and FIG. 8D showing a widthwise side view. Similar to the lighting element in FIGS. 7A-7D, the semiconductor-based lighting element 805 in FIGS. 8A-8D includes a light-emitting diode (LED) 825 preferably of the through-hole variety, surrounded by an optical cap 806. The LED 825 may, for example, be of conventional design similar to that previously described in connection with FIGS. 7A-7D. The LED 825 has two electrical connectors 809, i.e., anode and cathode pins, which are to be connected to an electric power source for selectively powering the LED 825, thereby turning it on and off.

In this particular embodiment, again similar to FIGS. 7A-7D, the optical cap 806 is preferably a multi-layer structure composed of a first layer 814, which may be transparent or clear, and a second layer 816, which may be so constructed as to provide diffusion for illumination from the LED 825. In this example, the first (transparent or clear) layer 814 has a sloped upper surface 819 having a central bend between two surfaces of differing angles. The second (diffusive) layer 816 generally follows the contours of the first layer 814. The second layer 816 may be formed from tinted or semi-opaque epoxy, plastic, or other such material, or may be formed in whole or part with a textured surface, or by some other suitable means in order to achieve its diffusive quality. In this particular example, the top surface of the second layer 816 includes a relatively flat or slightly angled surface region 831, a second more sharply angled or slightly curved surface region 832, and a third even more sharply angled surface region 833. The top surface of the second layer 816 may therefore become gradually more tapered from a relatively flat or slightly angled slope to a relatively shaper slope of, e.g., approximately 45 degrees.

The tapered shape of the optical cap 806 may provide certain benefits, particular for outdoor use, such as on a transit vehicle. It has been observed by the inventors that a fully convex surface shape of the optical cap may suffer from occasional glare depending upon the angle of incident sunlight. Such glare may make it more difficult for onlookers to read the messages displayed on the electronic signboard. The shape of optical cap 806 is designed to reduce or prevent glare, in one aspect, by avoiding a surface configuration that reflects the sunlight towards onlookers at street level. To this end, the longer sidewall 811 of the optical cap 806 is intended to be positioned facing upwards (towards the sky when outdoors) while the shorter sidewall 812 is intended to face downwards (towards the ground). The illumination from the LED 825 still spreads relatively evenly over the top surface of the optical cap 806, giving the appearance of a uniformly lit pixelated element in the display. However, sunlight that is incident upon the optical cap 806 will generally be reflected upwards from the long sidewall 811. While some glare still is possible, the flat surface region 831 of the optical cap 806 reduces greatly the angles at which sunlight can create problematic glare, such that glare might normally occur only when the sun is at a relatively low angle.

The dimensions of the optical cap 806 of the semiconductor-based lighting element 805 may be selected so as to be of suitable size and shape so as to provide a pixelated element of a high fill-factor two-dimensional grid as shown, for example, in FIGS. 2, 3 and 4C. As noted in connection with FIGS. 7A-7D, the optical cap 806 is preferably of a large enough size so as to substantially fill the two-dimensional grid when populated with semiconductor-based lighting elements 805 of the same type, but small enough to provide adequate resolution when forming pixelated text on the electronic display sign. For similar reasons, the optical cap 806 may be generally rectangular in shape, when viewed from the top and as it will appear when positioned on an electronic display sign, although other shapes (such as hexagonal or triangular) may also be used.

The area dimensions of the top surface of the optical cap 806 are preferably as mentioned in connection with FIGS. 7A-7D, that is, greater than 50 square millimeters, and may, for example, be in the range of 75-100 square millimeters. In the example illustrated in FIGS. 8A-8D, and as shown particularly in FIG. 8A, the lengthwise dimension of optical cap 806 is 10 millimeters, and the width dimension of the optical cap 806 is 8 millimeters, for a total surface area of 80 millimeters. Either of these dimensions may be varied depending upon the particular needs for a given application. The comparative size of the illuminated surface of the semiconductor-based lighting element 805 in FIGS. 8A-8D relative to convention LEDs is generally similar to the representations illustrated in FIG. 6, previously discussed.

In this example, the optical cap 806 has faceted corners with cuts 818 across each, although in other embodiments the corners may be sharp. As noted previously, the faceted corners may facilitate handling of the semiconductor-based lighting elements 805 and assembly of the electronic display signs made therewith.

The optical cap 806 is preferably of sufficient height to allow the illumination from the LED 825 light source to spread so as to adequately fill the top surface area of the optical cap in a relatively even fashion. In the example illustrated in FIGS. 8A-8D, the transparent layer 814 is approximately 6.5 millimeters in height on the shorter side, and approximately 13 millimeters in height at the higher side. Put otherwise, the height of the taller sidewall 811 of the optical cap 806 is about double that of the shorter sidewall 812 in this example, although other ratios or heights may also be utilized. The LED 825 in this instance is positioned at about 4 millimeters height within the first (transparent or clear) layer 814. The second (diffusion) layer 816 may be approximately 3 millimeters thick, adding another few millimeters of distance from the LED 825 to the top surface of the optical cap 806. The thickness of the second (diffusion) layer 816 also depends in part on the opacity of the material used to form that layer. Preferably, the second layer 816 is constructed so as to scatter or diffuse at least some of the illumination from LED 825, reducing total light output in the process by somewhere between 20% and 30%, and typically in the range of 25%. While this has the effect of reducing the total luminosity of the semiconductor-based lighting element 805, it has the benefit of also reducing the sharpness of the LED 825 as a point light source and instead gives the lighting element 805 the appearance of more of a solid light block.

Although through-hole LEDs are illustrated as the primary illumination source in the example of FIGS. 7A-7D and 8A-8D, it is alternatively possible to use other types of lighting sources, such as surface mount LEDs, instead. In such a case, the optical cap dimensions and positioning may be adjusted as needed to provide an appropriate spread of light from the surface mount or other LED or light source.

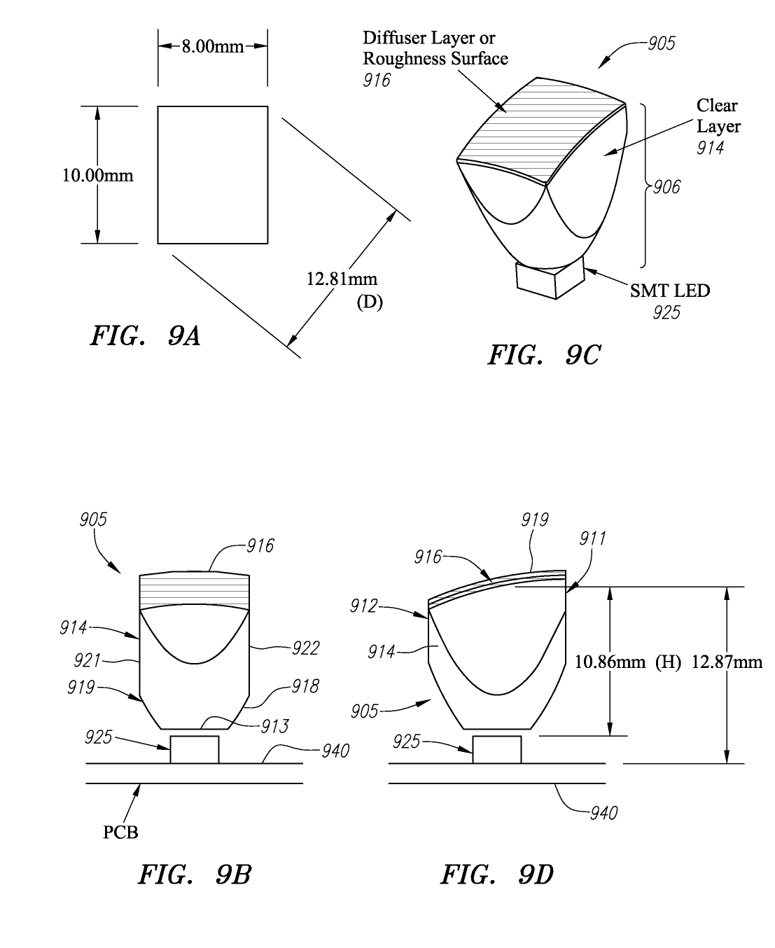

FIGS. 9A-9D are diagrams from various perspectives related to yet a third example of a semiconductor lighting element 905 with an optical cap 906 as may be used in connection with various electronic display signs as described herein, according to another embodiment. Specifically, FIG. 9A shows a (simplified) top view measurements of the semiconductor-based lighting element 905, FIG. 9B shows a lengthwise side view of the semiconductor-based lighting element 905, FIG. 9C shows an oblique view, and FIG. 9D shows a widthwise side view. In the example of FIGS. 9A-9D, the semiconductor-based lighting element 905 includes a light-emitting diode (LED) 925 preferably of the surface-mount variety, although other types of LEDs (such as through-hole) or other lighting elements may be used. The surface-mount LED 925 is mounted on a mounting surface such as a printed circuit board 940 or other surface, having electrical wires for conveying signals to and from the surface-mount LED 925. The surface-mount LED 925 may, for example, be of conventional design, and is preferably in the range of 50 to 100 milliwatts in power rating, although other LED types may be used depending on their efficiency and light output. For example, a 3.3 Volt lighting element drawing 25 milliamps would consume about 82 milliwatts, or somewhat under 100 milliwatts.

In this particular embodiment, the surface-mount LED 925 is preferably covered by an optical cap 906, which again may be a multi-layer structure composed of a first layer 914, which may be transparent or clear, and a second layer 916, which may be so constructed as to provide diffusion for illumination from the LED 925. In this example, the first (transparent or clear) layer 914 has a sloped or modestly curved upper surface 919 resulting in the optical cap 906 having a taller side 911 and a shorter side 912. The second (diffusive) layer 916 generally follows the contours of the first layer 914. The second layer 916 may be formed from tinted or semi-opaque epoxy, plastic, or other such material, or may be formed in whole or part with a textured surface, or by some other suitable means in order to achieve its diffusive quality. The optical cap 906 may be attached to the surface mount LED 925 with epoxy, or by other means, such as by screwing into a threaded cylinder (not shown) surrounding the LED 925. Although in this example, the upper surface 919 of the second layer 916 is slightly rounded in an asymmetrical fashion, alternatively the upper surface 919 may be formed with a graduated series of tapered sides or facets, similar to that shown in FIGS. 8A-8D for instance, but with a less steep final angle.

In this example, the optical cap 906 is generally “tulip shaped” or parabolic in nature, expanding outwardly with height. The optical cap 906 preferably has a flattened bottom surface 913 above the surface-mount LED 925, and faceted sidewalls including angled or slightly rounded lower sidewalls 918, 919, and nearly vertical flat or slightly rounded upper sidewalls 911, 912, 921, 922. The faceted sidewalls in this case may facilitate handling of the semiconductor-based lighting elements 905 and assembly of the electronic display signs made therewith, and also may help increase the fill factor of such signage.

The tapered shape of the upper surface 916 of the optical cap 906 may provide certain benefits in glare reduction, similar to the optical cap 806 shown in FIGS. 8A-8D. The longer sidewall 911 of the optical cap 906 is intended to be positioned facing upwards (towards the sky when outdoors) while the shorter sidewall 912 is intended to face downwards (towards the ground). The illumination from the LED 925 still spreads relatively evenly over the top surface 916 of the optical cap 906, giving the appearance of a uniformly lit pixelated element in the display. However, sunlight that is incident upon the optical cap 906 will generally be reflected upwards from the long sidewall 911. While some glare still is possible, the flat portion of the top surface 916 adjacent the longer sidewall 911 reduces the angles at which sunlight can create problematic glare, such that glare might normally occur only when the sun is at a relatively low angle. Meanwhile, the generally convex shape of the lower portion of the top surface 916 adjacent the shorter sidewall 912 provides more evenly lit appearance for onlookers positioned at street level.

The dimensions of the optical cap 906 of the semiconductor-based lighting element 9805 may be selected so as to be of suitable size and shape so as to provide a pixelated element of a high fill-factor two-dimensional grid as shown, for example, in FIGS. 2, 3 and 4C. As noted already in connection with FIGS. 7A-7D and 8A-8D, the optical cap 906 in this example is likewise preferably of a large enough size so as to substantially fill the two-dimensional grid when populated with semiconductor-based lighting elements 905 of the same type, but small enough to provide adequate resolution when forming pixelated text on the electronic display sign. For similar reasons, the optical cap 906 may be generally rectangular in shape, when viewed from the top and as it will appear when positioned on an electronic display sign, although other shapes (such as hexagonal or triangular) may also be used.

The area dimensions of the top surface of the optical cap 906 are preferably as mentioned in connection with FIGS. 7A-7D and 8A-8D, that is, greater than 50 square millimeters, and may, for example, be in the range of 75-100 square millimeters. In the example illustrated in FIGS. 9A-9D, the lengthwise dimension of optical cap 906 is 10 millimeters, and the width dimension of the optical cap 906 is 8 millimeters, for a total surface area of 80 millimeters. Either of these dimensions may be varied depending upon the particular needs for a given application. The comparative size of the illuminated surface of the semiconductor-based lighting element 905 in FIGS. 9A-9D relative to convention LEDs is generally similar to the representations illustrated in FIG. 6, previously discussed.

The optical cap 906 is preferably of sufficient height to allow the illumination from the surface mount LED 925 to spread so as to adequately fill the area of the top surface 916 of the optical cap 906 in a relatively even fashion. In the example illustrated in FIGS. 9A-9D, the transparent layer 914 has an average height of approximately 10.86 millimeters, being slightly taller on its higher side and slightly shorter on its lower side. The second (diffusion) layer 916 may be less than 1 millimeter thick, where it is formed by a textured surface, or else is preferably approximately 3 millimeters thick when formed with a tinted or semi-opaque material such as epoxy or plastic. Preferably, the second layer 916 is constructed so as to scatter or diffuse at least some of the illumination from surface-mount LED 925, reducing total light output in the process by somewhere between 20% and 30%, and typically in the range of 25%. While this has the effect of reducing the total luminosity of the semiconductor-based lighting element 905, it has the benefit of also reducing the sharpness of the LED 925 as a point light source and instead gives the lighting element 905 the appearance of more of a solid light block.

Although examples of dimensions and ratings for various semiconductor-based lighting elements have been described above, it should be appreciated that the invention is not to be limited to any particular dimensions or power ratings, but instead can be used with a wide variety of shapes, sizes and illumination levels of lighting elements.

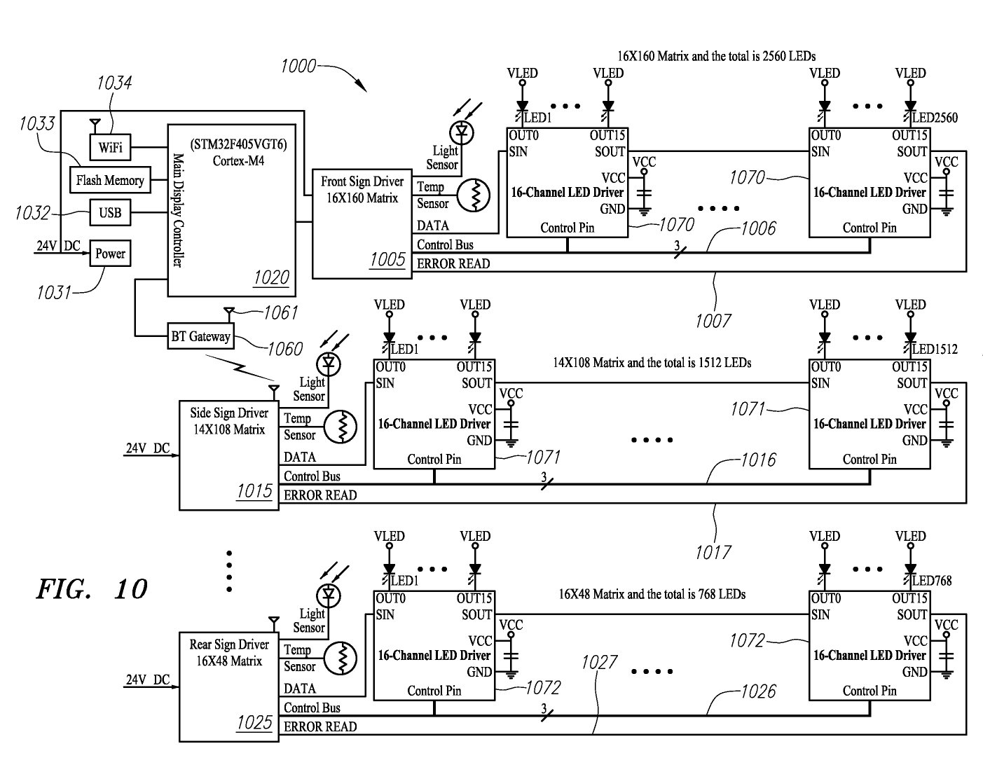

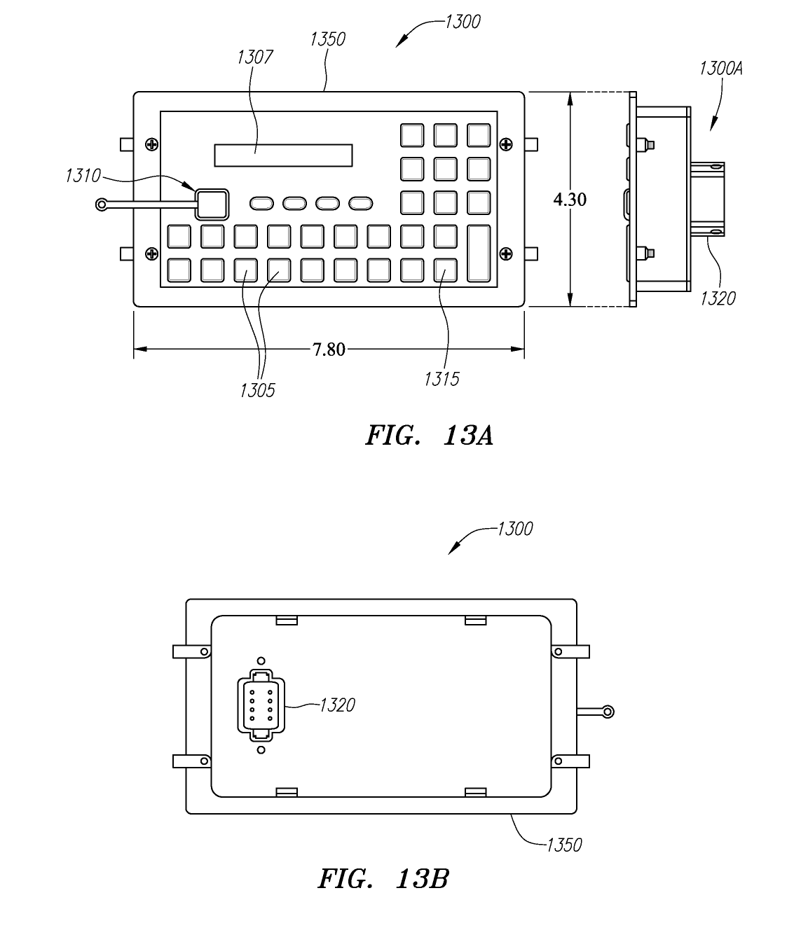

Electronic display signs constructed using the novel semiconductor-based lighting elements described herein may be electronically controlled by any of a variety of means, including wired or wireless control systems. FIG. 10 is a block diagram showing one example of a display system 1000 including electrical components for controlling and operating a set of electronic display boards, in accordance with one embodiment. In FIG. 10, the display system 1000 includes a main display controller 1020, which may be embodied as a processor (e.g., a microprocessor, microcontroller or other processor) such as a Cortex-M4 based STM32F405VGT6 manufactured by STMicroelectronics. The main display controller 1020 is communicatively coupled to one or more local drivers for each electronic display sign, in this case including a front sign driver module 1005, a side sign driver module 1015, and a rear sign driver module 1025. Although it can be collocated with the front display sign electronics, in a preferred embodiment the main display controller 1020 and its associated support circuitry is contained in an operator control unit (such as shown in FIGS. 13A-13B) that can be located in the interior of the vehicle. The main display controller 1020 may communicate to downstream components over a CAN bus or other similar connection, at a speed (such as 256 kbps) sufficient to scroll the text on all of the electronic display signs.

The main display controller 1020 in this example has a wired connection to the front sign driver module 1005 and a wireless connection to the side sign driver module 1015 and rear sign driver module 1025 via a wireless gateway 1060, although in other embodiments all or any of the communication paths may be wired or wireless. The wireless gateway 1060 may utilize a short-range communication protocol such as Bluetooth, and is outfitted with an antenna 1061 to facilitate local communication. The main display controller 1020 may incorporate or be electronically coupled to a flash memory 1033, serial bus port 1032 (such as a USB port), and an external wireless interface 1034 (e.g., a WiFi interface). The main display controller 1020 may receive power from a vehicle battery or other power source, and may include or be coupled to a power converter 1031 for adjusting the power level (from, e.g., 24 Volts) to a level suitable for the digital electronics of the main display controller 1020.

The front sign driver module 1005 connects to a series of LED drivers 1070 via a digital control bus 1006. The LED drivers 1070 are each electrically connected to a plurality of LEDs located on a front electronic display sign. Similarly, the side sign driver module 1015 connects to a series of LED drivers 1071 via a digital control bus 1016. The LED drivers 1071 are each electrically connected to a plurality of LEDs located on a side electronic display sign. The rear sign driver module 1025 connects to a series of LED drivers 1072 via a digital control bus 1026. The LED drivers 1072 are each electrically connected to a plurality of LEDs located on a rear electronic display sign. Although not shown in FIG. 10, a dash sign driver module and related LED drivers may also be provided and arranged in a similar fashion, for providing control signals to a dash electronic display sign.

In operation, the main display controller 1020 is either programmed to provide specific text messages or other graphical information to the electronic display signs, or else receives commands to display text or other information from an upstream source, such as an operator control unit (not shown in FIG. 10). The main display controller 1020 conveys appropriate display commands to the various sign driver modules 1005, 1015 and 1025, using the wired or wireless communication paths, according to well-known protocols. The sign driver modules 1005, 1015 and 1025 in turn convert the display commands to specific control signals directed to the LED drivers 1070, 1071 and 1072, respectively, which output electronic control signals to the specific LEDs or other lighting elements for individually controlling each LED or other lighting element. Each of the sign driver modules 1005, 1015, and 1025 may be configured to control a certain sized matrix of LEDs or semiconductor lighting elements; in this example, the front sign driver module 1005 is configured to control a matrix with 16 rows and 160 columns of lighting elements, the side sign driver module 1015 is configured to control a matrix with 14 rows and 108 columns of lighting elements, and the rear sign driver module 1025 is configured to control a matrix with 16 rows and 48 columns of lighting elements.

Each of the sign driver modules 1005, 1015, 1025 may also have a photosensor input and temperature sensor input, and can use the ambient light and local temperature information to adjust the control signals to the LEDs. For example, in brighter light, or during the daytime, the sign driver modules 1005, 1015 and/or 1025 may instruct the LED drivers 1070, 1071 and 1072 to drive the LEDs with more intensity so that they will be brighter, and/or in darker conditions, or during nighttime, the sign driver modules 1005, 1015 and/or 1025 may instruct the LED drivers 1070, 1071 and 1072 to curtail the intensity of the LEDs so that they are less harsh and easier to read. As but one example, the current provided to the lighting elements may be approximately 25 milliamps in daylight, but only between 3 and 4 milliamps at nighttime. The sign driver modules 1005, 1015, 1025 may use the temperature information to actively adjust the brightness level of the LEDs or other lighting elements so as to maintain a relatively constant brightness level, and may, for example, use a lookup table to associate particular temperatures with particular output signal levels such that constant brightness is achieved across different temperatures.

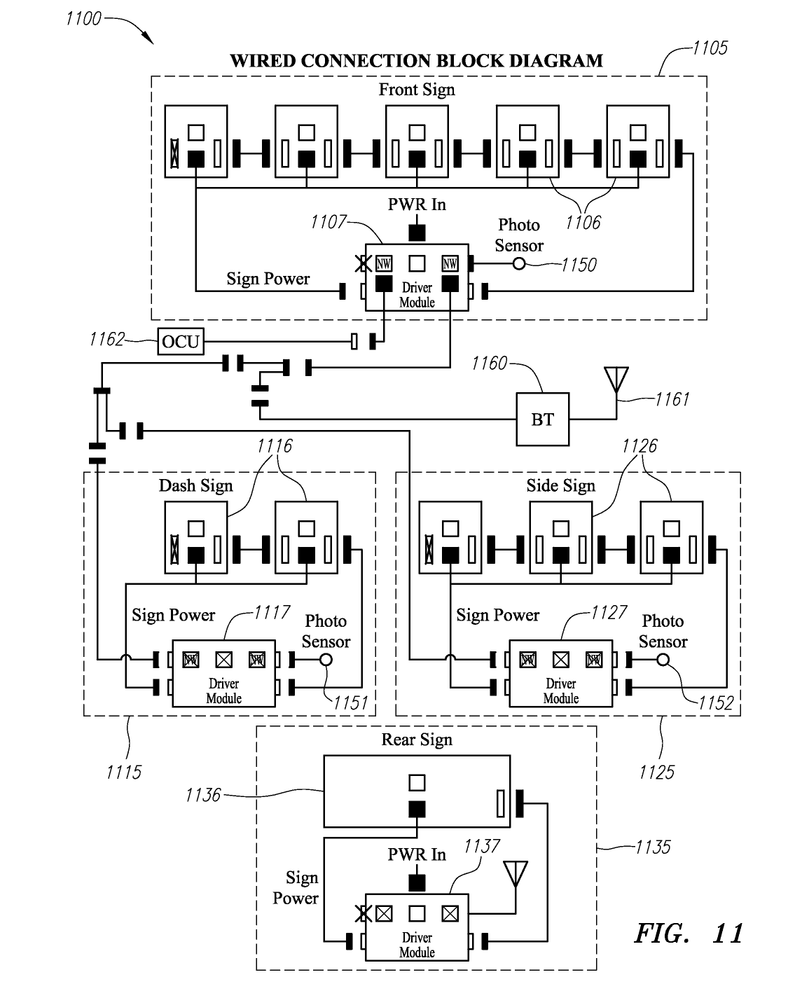

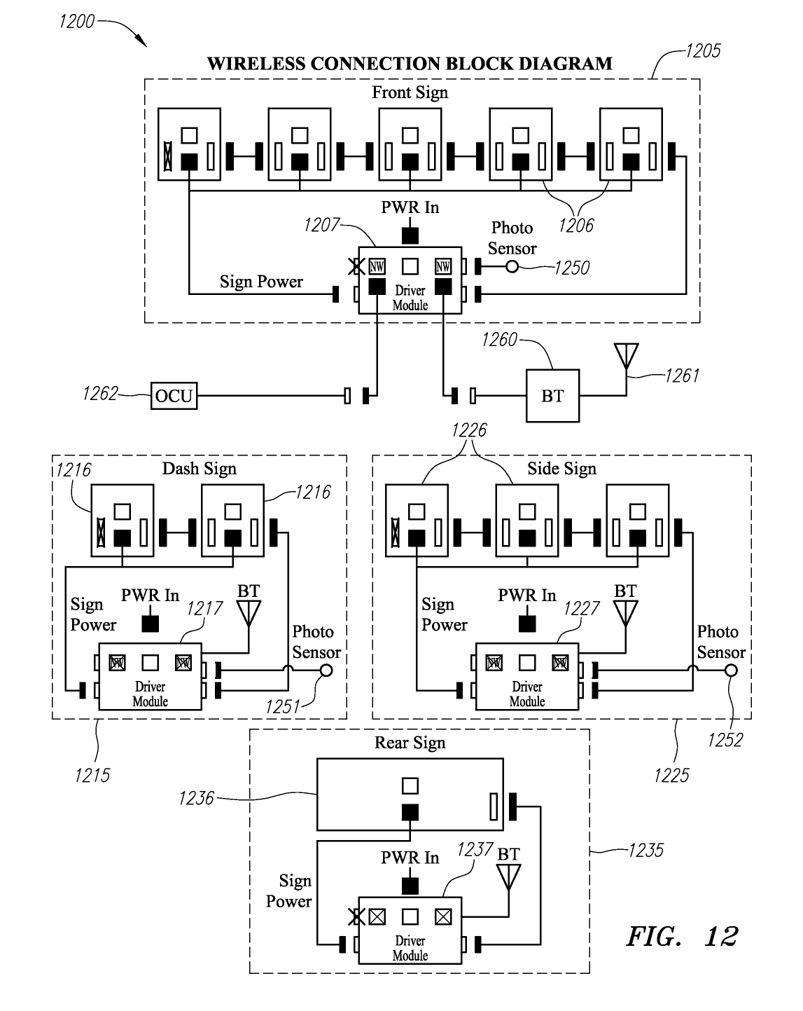

FIGS. 11 and 12 are block diagrams of system for controlling and operating a set of electronic display signs according to various examples as disclosed herein. In the system 1100 of FIG. 11, an operator command unit (OCU) 1162 is coupled to a front display sign control block 1105, and in particular to a front sign driver module 1107. The front sign driver module 1107 may be coupled to a series of LED drivers 1106 as previously described in connection with FIG. 10, and may thereby provide signals to the various LEDs or other lighting elements of the front display sign. The front sign driver module 1107 in this example also conveys command signals downstream to a dash sign driver module 1117 of a side display sign control block 1115 and a side sign driver module 1127 of a side sign control block 1125. The dash sign driver module 1115 may be coupled to a series of LED drivers 1116 for commanding the various LEDs or other lighting elements of the dash display sign, while the side sign driver module 1125 may be coupled to another series of LED drivers 1126 for commanding the various LEDs or other lighting elements of the side display sign. As generally explained previously, the front sign driver module 1107, dash sign driver module 1117, and side sign driver module 1127 (and optionally the rear sign driver module 1137) may be outfitted with photosensor inputs 1150, 1151 and 1152, respectively, for receiving data indicative of ambient light conditions and thereby allowing adjustment of the illumination intensity of the display boards in response thereto.

In addition, the system 1100 may also include a rear sign control block 1135 for controlling a rear display sign. In this example, the rear sign control block 1135 receives commands from a wireless gateway 1160 which may utilize a short-range wireless protocol such as, for instance, a Bluetooth protocol. The rear sign control block 1136 includes a rear sign driver module 1137 which may be coupled to one or more LED drivers 1136 for commanding the various LEDs or other lighting elements of the rear display sign. The rear sign driver module 1137 may have a wireless interface including an antenna and transceiver for receiving commands or other data from the front sign driver module 1107 or other upstream source.

In each of the above examples, the front display sign control block 1105, side display sign control block 1115, side sign control block 1125, and rear sign control block 1135 are integrated with the physical structure of the respective electronic display sign, and may reside in a self-contained housing or on a circuit board or other suitable platform associated with the electronic display sign. For example, FIG. 5C illustrates a driver module block 505 in which the control electronics including the driver module and possibly the LED drivers may reside, according to one example.

Using a wireless technique to communicate with the various electronic display signs, and particularly the rear display sign, can provide various advantages. For example, it may be expensive to provide cabling to wire the rear display sign at the back of the transit vehicle, which may be in the range of 40 feet from front to back. Also, a bulkhead is usually present towards the rear of the vehicle, and it can be difficult or inconvenient to route cabling past the bulkhead. Since a power source exists in the rear of the vehicle, it is not necessary to separately route power to the rear display sign. In a preferred embodiment, a short-range, low-power protocol such as Bluetooth (Class 1) is used for communicating with the rear display sign and any other wireless display signs, and the communication is bidirectional in nature. Class 1 provides 75 channels and provides the ability to shift wireless channels as may be needed. Conventional frequency hopping spread-spectrum (FHSS) chips or circuitry may be used for communication between the wireless components. A watchdog circuit, which may be located in the main display controller or in a control blocks for one of the electronic display signs, can monitor the communications to ensure that the messages are being received by the rear or other display signs. If there is a local interference source, such as from a passenger's wireless device, that is sustained for a given period of time (e.g., one or two minutes), and which blocks or interferes with communication, then, in response to the watchdog signal, the wireless controller may reset to a new channel by providing appropriate instructions to the FHSS chips or circuitry. In general, all of the wireless display signs would reset to the new channel at the same time, assuming the same wireless channel is shared among them (although in other embodiments each display sign may have its own wireless channel). Since the route or message information normally does not change rapidly, the watchdog circuit need not reset the channels too quickly, thus preventing a ping-pong effect. As an alternative to using a watchdog circuit, the receiver electronics may monitor and report received signal quality (e.g., number of errors and/or signal strength) and either report that data upstream or else request the signal channel to be switched.

FIG. 12 is a block diagram showing another example of a system 1200 for controlling and operating a set of electronic display signs from a central controller. In FIG. 12, elements labeled “12xx” generally correspond to similar elements labeled “11xx” in FIG. 11. The general function of the front display sign control block 1205, side display sign control block 1215, side sign control block 1225, and rear sign control block 1235 are similar to the counterparts shown in FIG. 11; however, in the example of FIG. 12, the dash display sign driver module 1217 and side sign driver module 1227 also communicate, like the rear sign driver module 1237, with the front sign driver module 1207 using a wireless communication path and, more specifically, the wireless gateway 1260. The dash sign driver module 1117 and side sign driver module 1227 may each have a wireless interface including an antenna and transceiver for receiving commands or other data from the front sign driver module 1107 or other upstream source.

Although FIGS. 11 and 12 illustrate some possible arrangements for the control blocks and electronics for systems having multiple display signs, other system architectures are possible. To provide merely a few examples, the operator command unit may communicate directly with the dash, side and rear display sign control blocks rather than going through the front display sign control block 1105 or 1205, or some of the control blocks may share certain components or blocks. It is also possible to mix and match signs of different types, using (for example) an electronic display sign such as illustrated in FIG. 5D for the front overhead display sign on the vehicle, and more conventional LED-based signs on one or more other locations of the vehicle, although the control electronics may be similar in each case. Other variations are also possible.

Commands may be provided to the display sign control electronics in a variety of ways. For example, commands for displaying certain text or other information may be provided from an operator command unit to a front display sign control block and other destinations. FIGS. 13A and 13B are diagrams illustrating an example of an operator command unit 1300 that may be used in connection with the electronic sign display boards as disclosed herein, for operating or controlling them and interfacing with a transit vehicle driver or other operator. FIG. 13A shows front and side views of the operator command unit 1300, while FIG. 13B shows a rear view of it. In FIG. 13A, the operator command unit 1300's side view is designated as 1300A, and is shown in alignment with the frontal view for reference.

In FIGS. 13A and 13B, a command unit housing 1350 is shown encapsulating the internal electronics of the operator command unit 1300, such as a processor, memory, and various interfaces, for example, all generally comprising a conventional embedded computer system with adequate memory and processing power to perform the tasks of interfacing with an operator and controlling the electronic display signs located in various parts of the vehicle or other setting. The command unit housing 1350 may be generally rectangular as shown, and manufactured from a durable material (such as aluminum or plastic) resistant to moisture, dust and other external environmental conditions.

The operator command unit 1300 preferably has a small display 1307 for displaying text or other information to the operator, and a user input mechanism 1315 that may include, for example, a variety of buttons 1305 or other manual input devices such as knobs, levers, or the like. The user input mechanism 1315 may include either manual buttons or electronic (virtual) buttons, such as with a touchscreen. In one embodiment, the user input mechanism 1315 is a translucent letter and symbol backlit keypad. The operator command unit 1300 further preferably has a connector plug socket 1320 for attaching a cable that connects to the display sign electronics such as previously described in connection with FIGS. 10, 11 and/or 12, so as to allow the transmission of digital commands or other data to the electronic display sign(s) downstream. A serial port 1310, such as a universal serial bus (USB) port, may also be provided for convenient local interaction with the operator command unit 1300.

The operator command unit 1300 may be located in proximity to a driver of a transit vehicle or other type of conveyance, and for example may be secured to the dash area or a nearby interior wall. In operation, the operator command unit 1300 may be pre-programmed with route information or other text for display, and may convey such information as needed to the electronic display signs, in a manner as known conventionally in the art. The operator command unit 1300 may also have a wireless unit (not shown) for communicating with a remote operational station, thereby allowing it conveniently to receive new route information or other periodic updates to software or data. In various embodiments as disclosed herein, the operator command unit 1300 may store text, message, images or other display information locally, in a durable memory, or else may receive data for display from a remote source, including a remote wireless (e.g., RF) source. The operator may, for example, select a route or destination from a menu, or may press a particular button 1305 to invoke a pre-programmed route display routine. The route messages may appear on the display 1307 as the transit vehicle operates, in tandem with the message that appears on the external display signs.

The operator command unit 1300 and associated display sign electronics may be part of a standalone subsystem, or else may be tied into a larger vehicle control network. Thus, in some embodiments, the display sign control electronics system may comprise a subsystem of the control network of the vehicle, although in other embodiments the display sign control electronics may be standalone or independent of the main vehicle control network.

The electronic display signs described herein may be physically attached to a transit vehicle or other stable surface by any suitable means. Electrical power may be provided to the electronic display signs from local connections to the vehicle power system. If necessary, an electronic display sign and/or its associated control electronics may include or be coupled to a power converter or regulator for providing an appropriate power signal level for the control electronics and lighting elements of the display signs.

While in some embodiments, the lighting elements will all be uniformly of the same color, in other embodiments the lighting elements may be of different colors. For example, the lighting elements may be red, green and blue (RGB), or red and white, or all uniformly white or amber. In a preferred embodiment, the lighting elements are amber or yellow or coloration, which may provide superior contrast and hence better viewability in outdoor settings, when utilized in conjunction with the novel optical caps as disclosed herein.

In various embodiments constructed in accordance with the teachings and disclosure herein, an illuminated electronic sign display board for a transit vehicle may comprise a support frame with a mounting surface, a plurality of semiconductor-based lighting elements disposed on or securably attached to the mounting surface and preferably arranged in a two-dimensional grid or similar layout, and electronic circuitry configured to provide commands to selectively illuminate the semiconductor-based lighting elements so as to create at least text information thereon. The semiconductor-based lighting elements may each comprise a light source and an optical cap, where the optical caps are aligned in the rows and columns of the two-dimensional grid and are substantially adjacent to one another, with only relatively narrow gaps therebetween.

In certain embodiments, the optical caps may be substantially rectangular in shape, and may further have an asymmetric top surface. The optical caps may be higher (or taller) in a direction towards the top edge of the electronic display sign, that is, towards the top of the vehicle, and lower (or shorter) in a direction towards the bottom edge of the electronic display sign, that is, towards the bottom of the vehicle. In this way, glare can be reduced at many incident angles of sunlight, making it easier to read the display sign. The top surface of the optical caps may advantageously be continuously tapering from a first top surface boundary to a second top surface boundary; for example, it may be semi-rounded or faceted. The top surface may start relatively flat at the first top surface boundary adjacent the taller sidewall, forming a substantially right angle corner therewith, and progressively angle downward towards the second top surface boundary, where it meets the shorter sidewall of the optical cap. The light source (e.g., LED) of the semiconductor-based lighting elements is preferably positioned substantially in the center of the optical cap from a top view perspective.

In aspects or embodiments, the optical caps may be multi-layer, with a first transparent layer and a second diffusive layer atop the first layer. The diffusive layer may be formed with a semi-opaque or tinted material, and/or by a textured upper surface of the optical cap. The first transparent layer and second diffusive layer may advantageously both be wholly formed from epoxy placed in a concave mold, without an outer containing shell being needed to contain the epoxy.

In various embodiments, the optical caps occupying more total surface area than the total surface area occupied by the linear gaps, and preferably each have a top surface area of more than 50 square millimeters. The width of the gaps between rows and columns of the lighting elements is preferably relatively small, such as less than 4 millimeters, and preferably around 2 to 3 millimeters. Parallel slats may be disposed in either or both of the gaps between columns and the gaps between rows of semiconductor-based lighting elements. The electronic display board may have a display area of three square feet or more, yet be rated to draw a maximum current of less than 10 Amps. The frame of the electronic display board may be comprised of a plurality of separate modules physically attached in series and electrically connected to one another, each of the separate modules supporting a subset of the semiconductor-based lighting elements.

In certain embodiments, the semiconductor-based lighting elements comprise surface mount light emitting diodes (LEDs), with an optical cap disposed thereon, or may comprise through-hole light emitting diodes (LEDs) each surrounded by and integrated with one of the optical caps. The semiconductor-based lighting elements may be any suitable color, but are preferably yellow or amber in color.

In another embodiment, an illuminated electronic display sign for a transit vehicle may comprising a support frame with a mounting surface, a plurality of lighting elements disposed on or securably attached to the mounting surface and covering a display area for generating at least text information, and electronic circuitry configured to provide commands to selectively illuminate the lighting elements so as to create the text information thereon, wherein the lighting elements each comprise a semiconductor-based light source and an optical cap, and wherein the optical caps each comprise a transparent portion and a diffusion portion. The optical caps may be aligned in a two-dimensional grid having rows and columns and are substantially adjacent to one another, with gaps defined between the rows and columns, and wherein a display area defined by a total viewable surface area of said optical caps exceeds a total area of the gaps between the rows and columns.

In various embodiments, an electronic display sign and associated system constructed in accordance with the principles and techniques disclosed herein may exhibit a number of advantages and/or useful characteristics. For example, the electronic display sign in various embodiments may have improved readability and clarity, and resistance to glare. The display sign may also have a long useful lifetime, require minimal maintenance, and be relatively inexpensive to build and maintain as a result. The electronic display signs in various embodiments described herein may also consume less power, or a limited amount of power, thereby making them particularly well suited for use on the external locations of transit vehicles where limited power may be available, while still providing a very readable and flexible display arrangement with a high fill factor. The electronic display signs may be relatively easy to install or retrofit, and may take up minimal space, having a very low profile. The electronic display signs may also be readily integrated with vehicle electronics or control system.

Another advantage or benefit of certain embodiments of the electronic display signs as disclosed herein is that they are modular in nature, such that display signs may be made any desired length by, for example, changing the number of modules connected together. Also, by adjusting the number of rows or columns of semiconductor-based lighting elements, the size of the display sign can be readily adjusted. Different sized display sign fixtures may be mixed and matched within a transit vehicle, based on the same modules, offering great flexibility in physical layout and arrangement.

Because the information displayed on the electronic display signs is controlled digitally, it is possible to rapidly and easily change the information to be displayed through software commands. By contrast, display signs using mechanical means, such as flip-dots, generally have only a limited number of possible display settings.

While preferred embodiments of the invention have been described herein, many variations are possible which remain within the concept and scope of the invention. Such variations would become clear to one of ordinary skill in the art after inspection of the specification and the drawings. The invention therefore is not to be restricted except within the spirit and scope of any appended claims.

What is claimed is:

1. An illuminated electronic sign display board for a transit vehicle, comprising:
a support frame with a mounting surface;
a plurality of semiconductor-based lighting elements disposed on or securably attached to the mounting surface; and
electronic circuitry configured to provide commands to selectively illuminate the semiconductor-based lighting elements so as to create at least text information thereon;
wherein the semiconductor-based lighting elements each comprise a light source and an optical cap; and
wherein the optical caps are aligned in a two-dimensional grid and are substantially adjacent to one another.

2. The illuminated electronic sign display board of claim 1, wherein the optical caps are substantially rectangular in shape.

3. The illuminated electronic sign display board of claim 1, wherein the optical caps each have an asymmetric top surface.

4. The illuminated electronic sign display board of claim 3, wherein the optical caps are higher in a direction of a top edge of the electronic display sign, and lower in a direction of a bottom edge of the electronic display sign.

5. The illuminated electronic sign display board of claim 3, wherein the optical caps have a continuously tapering top surface from a first top surface boundary to a second top surface boundary.

6. The illuminated electronic sign display board of claim 5, wherein the top surface is substantially flat at the first top surface boundary, forming a substantially right angle corner therewith, and progressively angles downward towards the second top surface boundary.

7. The illuminated electronic sign display board of claim 1, wherein the light source of the semiconductor-based lighting elements is positioned substantially in the center of the optical cap from a top view perspective.

8. The illuminated electronic sign display board of claim 1, wherein the optical caps are multi-layer.

9. The illuminated electronic sign display board of claim 8, wherein the optical caps include a first transparent layer and a second diffusive layer.

10. The illuminated electronic sign display board of claim 9, wherein the diffusive layer is formed with a semi-opaque or tinted material.

11. The illuminated electronic sign display board of claim 9, wherein the diffusive layer is formed by a textured upper surface of the optical cap.

12. The illuminated electronic sign display board of claim 9, wherein the first transparent layer and second diffusive layer are both wholly formed from epoxy without an outer containing shell.

13. The illuminated electronic sign display board of claim 1, wherein the optical caps align in a two-dimensional array with linear gaps between rows and columns of the optical caps, with the optical caps occupying more total surface area than the total surface area occupied by the linear gaps.

14. The illuminated electronic sign display board of claim 13, wherein the optical caps each have a top surface area of more than 50 square millimeters.

15. The illuminated electronic sign display board of claim 14, wherein the optical caps each have a top surface with a length dimension and a width dimension defining a diagonal with dimension D and have a height of dimension H, wherein a ratio of H:D is between 1:0.59 and 1:2.36.

16. The illuminated electronic sign display board of claim 14, wherein a width of said gaps is less than 4 millimeters.

17. The illuminated electronic sign display board of claim 14, further comprising a plurality of parallel slats disposed in either or both of the gaps between columns and the gaps between rows of semiconductor-based lighting elements.

18. The illuminated electronic sign display board of claim 1, wherein the electronic display board has a display area of at least three square feet and is rated to draw less than 10 Amps of current maximum.

19. The illuminated electronic sign display board of claim 1, wherein said semiconductor-based lighting elements comprise surface mount light emitting diodes (LEDs).

20. The illuminated electronic sign display board of claim 1, wherein said semiconductor-based lighting elements comprise through-hole light emitting diodes (LEDs) each surrounded by and integrated with one of the optical caps.

21. The illuminated electronic sign display board of claim 1, wherein said semiconductor-based lighting elements are yellow or amber in color.

22. The illuminated electronic sign display board of claim 1, wherein said frame is comprised of a plurality of separate modules physically attached in series and electrically connected to one another, each of the separate modules supporting a subset of the semiconductor-based lighting elements.

23. An illuminated electronic display sign for a transit vehicle, comprising:
a support frame with a mounting surface;
a plurality of lighting elements disposed on or securably attached to the mounting surface and covering a display area for generating at least text information; and
electronic circuitry configured to provide commands to selectively illuminate the lighting elements so as to create the text information thereon;
wherein the lighting elements each comprise a semiconductor-based light source and an optical cap; and
wherein the optical caps each comprise a transparent portion and a diffusion portion.

24. The illuminated electronic display sign of claim 23, wherein the optical caps are aligned in a two-dimensional grid having rows and columns and are substantially adjacent to one another, with gaps defined between the rows and columns, and wherein a display area defined by a total viewable surface area of said optical caps exceeds a total area of the gaps between the rows and columns.

25. The illuminated electronic display sign of claim 23, wherein the optical caps are substantially rectangular in shape.

26. The illuminated electronic display sign of claim 23, wherein the optical caps each have an asymmetric top surface.

27. The illuminated electronic display sign of claim 26, wherein the optical caps are higher in a direction of a top edge of the electronic display sign, and lower in a direction of a bottom edge of the electronic display sign, and have a continuously tapering top surface from a first top surface boundary to a second top surface boundary.

28. The illuminated electronic display sign of claim 27, wherein the top surface is substantially flat at the first top surface boundary, forming a substantially right angle corner therewith, and progressively angles downward towards the second top surface boundary.

29. The illuminated electronic display sign of claim 23, wherein the transparent portion of the optical caps comprises a first transparent layer and the diffusive portion of the optical caps comprises a second diffusive layer atop the first transparent layer.

30. The illuminated electronic display sign of claim 29, wherein the diffusive layer is formed with a semi-opaque or tinted material.

31. The illuminated electronic display sign of claim 29, wherein the diffusive layer is formed by a textured upper surface of the optical cap.

32. The illuminated electronic display sign of claim 29, wherein the first transparent layer and second diffusive layer are both wholly formed from epoxy without an outer containing shell.

33. The illuminated electronic display sign of claim 23, wherein the optical caps each have a top surface area of more than 50 square millimeters.

34. The illuminated electronic display sign of claim 23, wherein the optical caps each have a top surface with a length dimension and a width dimension defining a diagonal with dimension D and have a height of dimension H, wherein a ratio of H:D is between 1:0.59 and 1:2.36.

35. The illuminated electronic display sign of claim 24, wherein a width of said gaps is less than 4 millimeters.

36. The illuminated electronic display sign of claim 23, wherein the electronic display board has a display area of at least three square feet and is rated to draw less than 10 Amps of current maximum.

37. The illuminated electronic display sign of claim 23, wherein said semiconductor-based light sources comprise surface mount light emitting diodes (LEDs).

38. The illuminated electronic display sign of claim 23, wherein said semiconductor-based light sources comprise through-hole light emitting diodes (LEDs) each surrounded by and integrated with one of the optical caps.

39. The illuminated electronic display sign of claim 23, wherein said semiconductor-based lighting elements are yellow or amber in color.
